(19) United States
(12) Patent Application Publication
(10) Pub. No.: US 2002/0038293 A1
(43) Pub. Date: Mar. 28, 2002

(54) Web-enabled method and system for managing remote dispute resolution

(76) Inventor: Henry A. Seiden, West Palm Beach, FL (US)

Correspondence Address: Holland & Knight LLP, Suite 2300, 400 N. Ashley Drive, Tampa, FL, 33602, US

(21) Appl. No.: 09/906,027

(22) Filed: Jul. 13, 2001

Related U.S. Application Data
(60) Provisional application No. 60/218,395, filed on Jul. 14, 2000.
(60) Provisional application No. 60/280,037, filed on Mar. 30, 2001.

(51) Int. Cl. H04K 1/00; H04L 9/00; G06F 17/60

(52) U.S. Cl. 705/80

(57) ABSTRACT

A web-enabled or on-line ADR method and system that permits businesses and litigants to engage in dispute resolution totally online. Unlike known online ADR methods summarized above which primarily engage in e-mail exchanges, the present invention provides ADR services through the use of customized video conferencing being integrated into the system to allow participation in the ADR process in real-time and face-to-face via video conferencing.

### CROSS-REFERENCE TO RELATED APPLICATIONS

This application claims priority from provisional application Ser. No. 60/218,395, filed Jul. 14, 2000 and from provisional application Ser. No. 60/280,037, filed Mar. 30, 2001, the disclosures of both of which are hereby incorporated herein.

### BACKGROUND OF THE INVENTION

1. Field of the Invention This invention relates to a computerized system and method for managing dispute resolution. More particularly, this invention relates to a web-enabled method and system for remotely managing and conducting real time audiovisual interaction among multiple parties participating in a dispute resolution session.

2. Description of the Background Art

Alternative dispute resolutions (ADR) generally include early neutral evaluations, mediations, and non-binding arbitrations. Due to the high rate of success in reaching settlement, one or more of these types of ADR are employed in virtually all litigation.

Historically, ADRs are conducted in-person. Conducting ADRs by means of video conferencing is sometimes employed to minimize travel costs. In recent years, web-enabled or on-line mediation tools have become available. Most on-line mediations utilize e-mail for scheduling the mediation and then actually conducting the mediation. Unfortunately, since the process is conducted by sending and responding to e-mails, an on-line mediation typically occurs over the course of days or weeks. To minimize these drawbacks, most on-line mediation systems impose time limitations for responding to each e-mail communication. Similar difficulties are encountered in attempting to draft and revise a settlement agreement by e-mail exchanges.

Examples of known on-line mediation systems, but which do no necessarily constitute prior art to the present invention, include http://www.mediate-net.org/ and http://www.clicknsettle.com/. The latter of these, http://www.clicknsettle.com/, has recently announced plans for integrating video conferencing into its on-line mediations. However, the details of such integration have not yet been published.

Therefore, it is an object of this invention to provide an improvement which overcomes the aforementioned inadequacies of current web-enabled or on-line ADR systems and provides an improvement which is a significant contribution to the advancement of the art.

Another object of this invention is to provide a web-enabled or online ADR tool that eliminates or minimizes the use of e-mail to conduct the mediation.

Another object of this invention is to provide a web-enabled or online ADR tool that employs video conferencing for viewing by respective participants and the mediator via a web browser.

Another object of this invention is to provide a web-enabled or online ADR tool that enables respective participants to log into a dispute resolution session being conducted by a mediator.

Another object of this invention is to provide a web-enabled or online ADR tool that enables a dispute resolution session to be controlled by a mediator who may selectively activate and deactivate audio visual communication devices accessible to each participant thereby allowing private caucuses with the respective participants.

The foregoing has outlined some of the pertinent objects of the invention. These objects should be construed to be merely illustrative of some of the more prominent features and applications of the intended invention. Many other beneficial results can be attained by applying the disclosed invention in a different manner or modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### SUMMARY OF THE INVENTION

For the purpose of summarizing the invention, the invention comprises a web-enabled or on-line ADR method and system that permits businesses and litigants to engage in dispute resolution totally online. Moreover, unlike known online ADR methods summarized above which primarily engage in e-mail exchanges, the present invention provides ADR services through the use of customized video conferencing being integrated into the system to thereby participate in the ADR process in real-time and face-to-face via video conferencing. Thus, the ADR method and system of the present invention allows quick and easy access to impartial mediators for dispute resolution anywhere, with anyone in the world, without the delay, trouble and expense of travel.

The ADR method and system of the present invention allows the parties to (1) schedule a dispute resolution session, e.g., early neutral evaluation, mediation, arbitration, etc.; (2) participate in a real-time negotiations with multi-parties, or privately in caucuses, under the direction of the evaluator, mediator or arbiter; (3) display pictures, PowerPoint presentations or video; and (4) conclude negotiations with electronic transmittal of settlement documents and payment. Thus, as can be appreciated, every major aspect of existing traditional and increasingly popular mediation processes are featured in the present invention in a virtual environment, while preserving the personal dynamics of communication and making scheduling and meeting more efficient and less costly.

More particularly, the scheduling module of the ADR method and system of the present invention facilitates locating one or more mediators stored in a database based on predefined parameters. The database may be responsive to a suitable server, each part of a web site managed and operated by the provider of the present invention. Examples of the predefined parameters may be mediators' name, mediators' specialty or both. The scheduling module further includes means for finding an open date/time for one or more mediators, and for booking a mediator for an available date/time.

The storage module of the ADR method and system of the present invention is configured to store data indicative of a mutually agreed time and date for conducting the mediation session including a respective mediator for conducting the mediation session.

The mediation-conducting module of the ADR method and system of the present invention allows respective participants from diverse locations to log into a specific session and participate therein through the use of respective audio/video conferencing devices that display video in on-screen windows. The mediation-conducting module further allows the mediator responsible for that specific session to selectively turn respective audio/visual conferencing windows off or on of the respective participants as the mediation session progresses. By way of example, the mediator may desire to communicate during respective portions of the mediation in private caucuses (e.g., privately with a first participant alone and then privately with a second participant). Thus, the system allows the mediator to turn off the audio/visual conferencing window of the second participant while privately caucusing with the first participant, and visa versa. In the preferred embodiment of the present invention, the audio/visual conferencing communication devices comprise devices configured to securely communicate over the Internet through the use of browsers.

The mediation-support module of the ADR method and system of the present invention allows respective participants to scan, transmit and display on-screen documents, photographs, Power Point presentations and other electronically formatted files that may be presented by respective participants of the mediation.

The settlement module of the ADR method and system of the present invention allows a subscriber to generate respective settlement/release documents including, if desired, initiation of funds transfers via a virtual bank.

The billing module of the ADR method and system of the present invention allows for tracking system usage so as to generate billing charges to respective participants and to tender payment to the mediator for services rendered. By way of example, the billing process may be initiated as part of the booking action.

The training module of the ADR method and system of the present invention allows student and/or participants users to sign up and receive any desired training.

The ADR method and system of the present invention can be embodied in the form of computer-implemented processes and apparatuses for practicing those processes. The present invention can also be embodied in the form of computer program code containing computer-readable instructions embodied in tangible media, such as floppy diskettes, CDROMs, hard drives, or any other computer-readable storage medium, wherein, when the computer program code is loaded into and executed by a computer, the computer becomes an apparatus for practicing the invention. The present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose computer, the computer program code segments configure the computer to create specific logic circuits or processing modules.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 comprises the various exemplary pages of the web site of the employing the invention;

FIG. 2 is a diagram showing the conferencing structure of the system of the invention;

FIG. 3 is a diagram showing the user flow in accordance with the invention;

FIG. 4 is a structural diagram showing the preferred implementation of the invention;

FIG. 5 is a database table diagram in accordance with the invention;

FIG. 6 is a diagram showing the Internet and application framework of the preferred embodiment of the invention;

FIG. 7 is a diagram showing the networking framework of the preferred embodiment of the invention; and

FIG. 8 is a diagram showing the scheduling flow in accordance with the invention.

### DETAILED DESCRIPTION OF THE PREFERRED EMBODIMENT

The ADR method and system of the present invention is webenabled allowing for online access via the Internet by participants through the use of a web browser. The architecture and application framework for the web site is set forth in the following technical specifications to provide a high-level overview of the web site, including interface, structure, existing features and functions, and the underlying technology (hardware and software) infrastructure.

### Overview of the Web Site

### Description of Actors and Target Users

Initially, for the purpose of better understanding the ADR method and system of the present invention, there exist three defined users: Controllers, Participants, and Administrators.

Controllers are the evaluators, mediators, and arbiters who are registered with the system and for whom schedules are maintained in the system. These are the parties who control the mediation process via the web application. The Administrator of the ADR method and system of the invention pays them for services rendered as a mediator upon completion of the mediation. Trainers are individuals who teach courses via the web application to students to learn how to utilize the ADR method and system of the invention. Collectively, mediators and trainers are referred to as Controllers. The term “mediator” may be used interchangeably with Controller, and is defined to include evaluators and arbiters.

Participants are the subscribers (individuals or corporations) who have subscribed to the system. They are the parties participating in a mediation with the mediator. They pay the Administrator of the ADR method and system of the present invention for the mediation, preferably in advance such as when the time is booked. Students are individuals who have registered to take a course via the web application. Collectively, subscribers and students are referred to as participants.

Administrators are individuals who are certified by provider the ADR method and system of the present invention to administer the web site and its applications.

### Content and Functionality

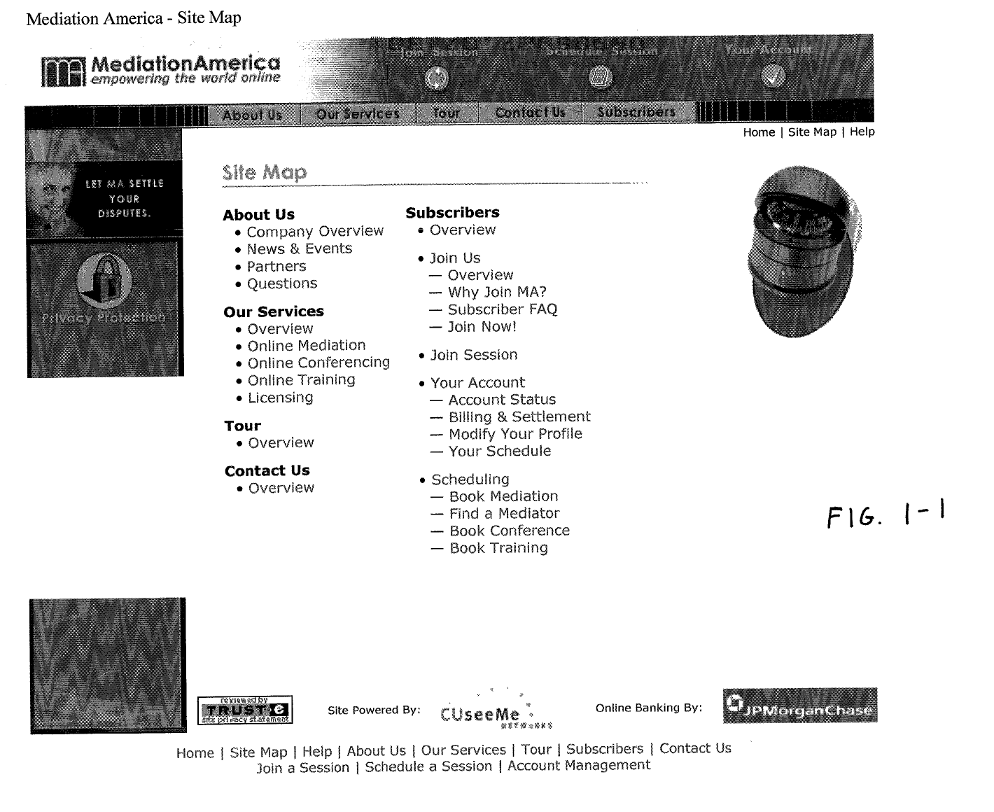

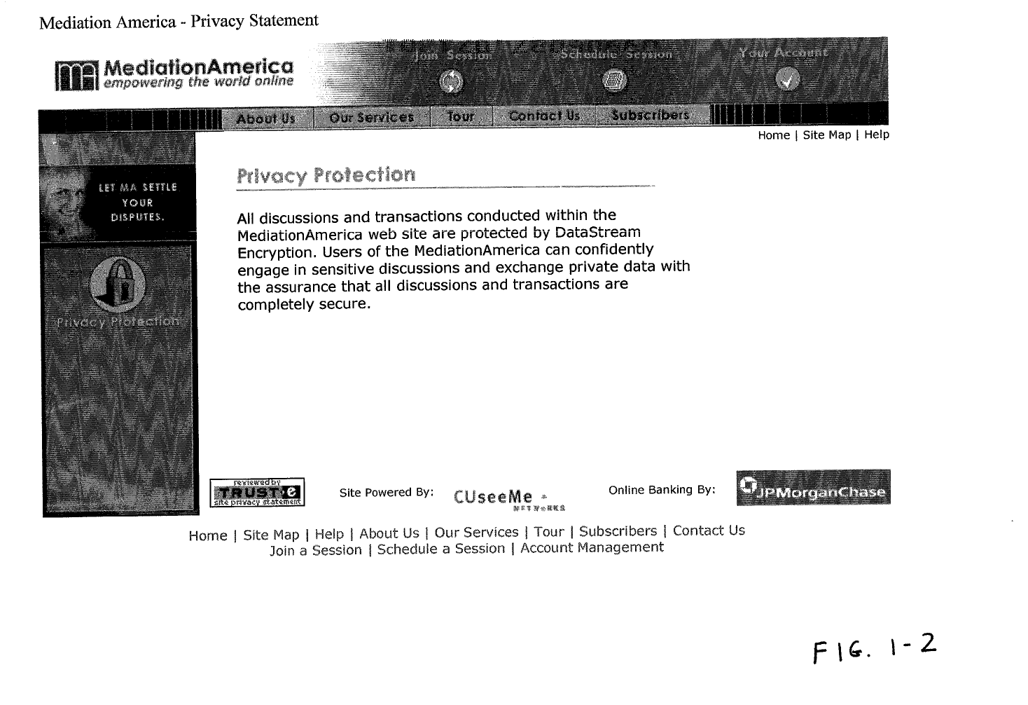

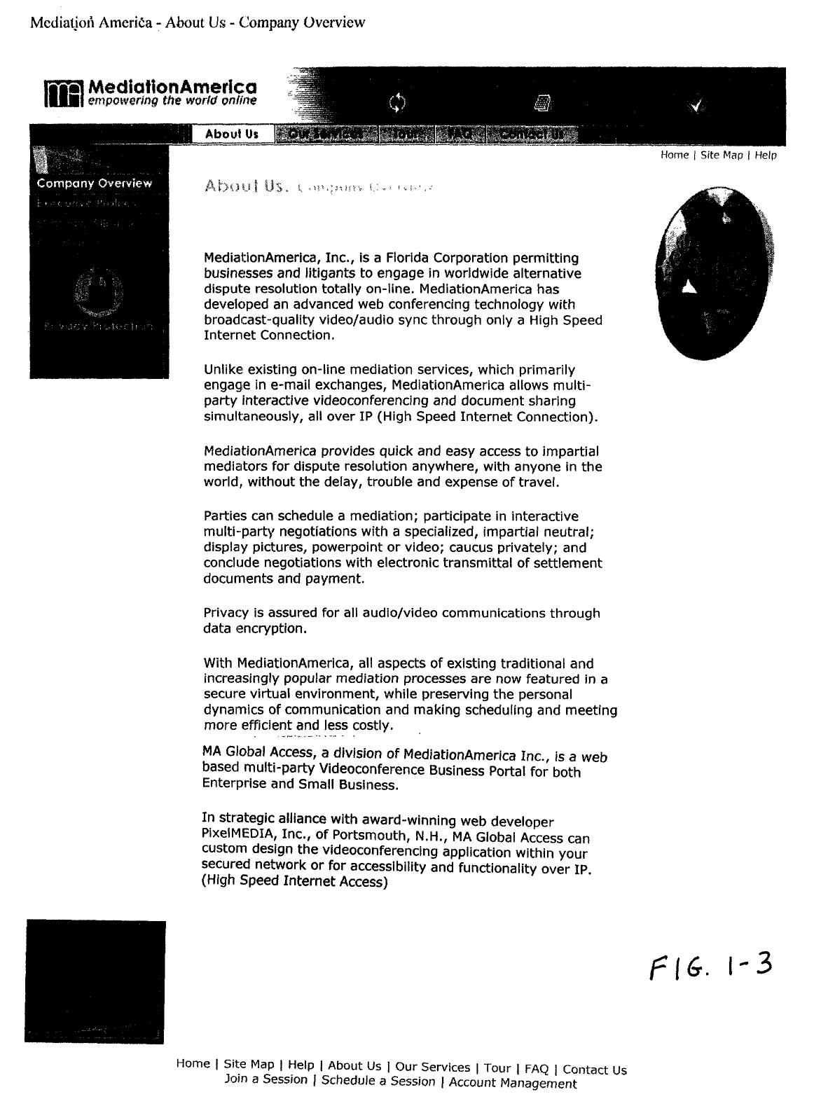

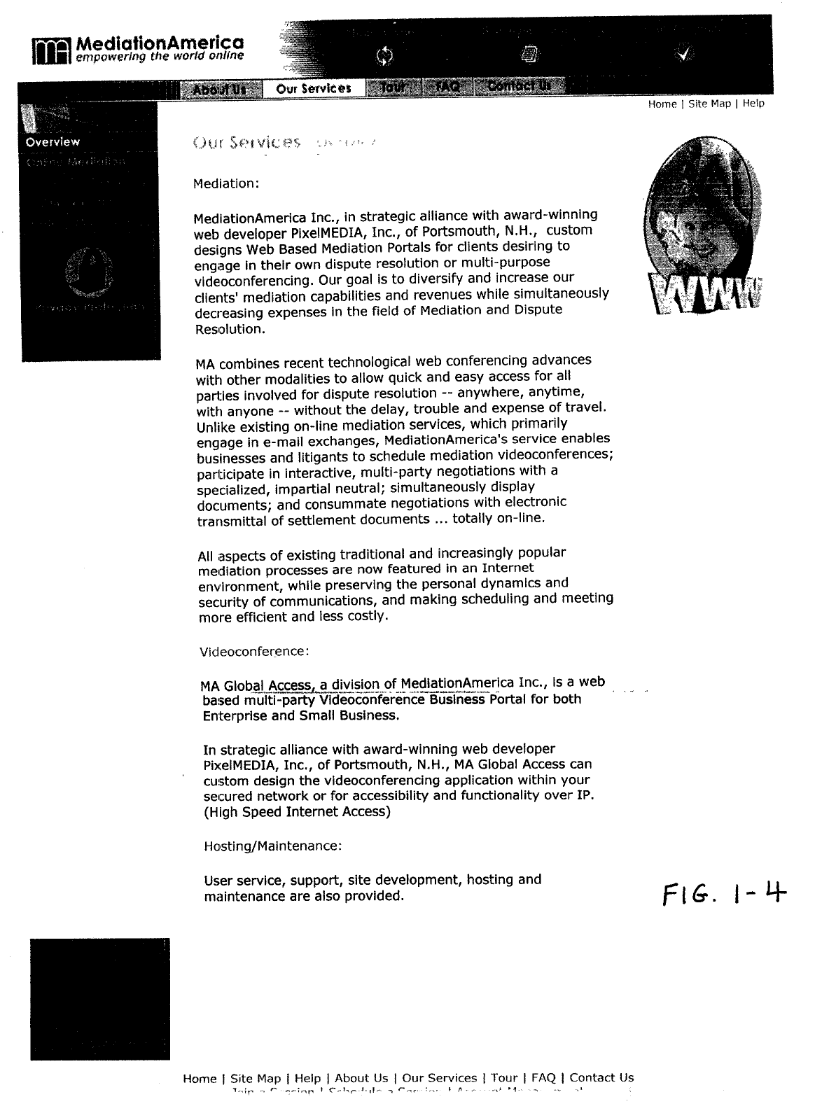

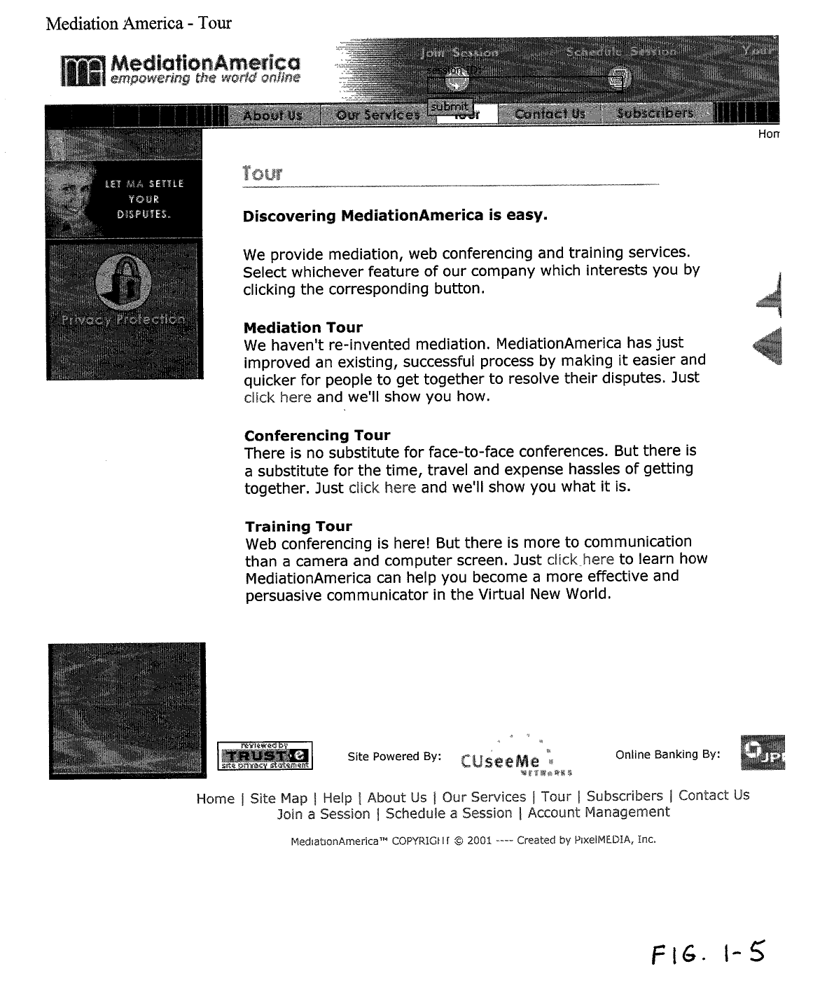

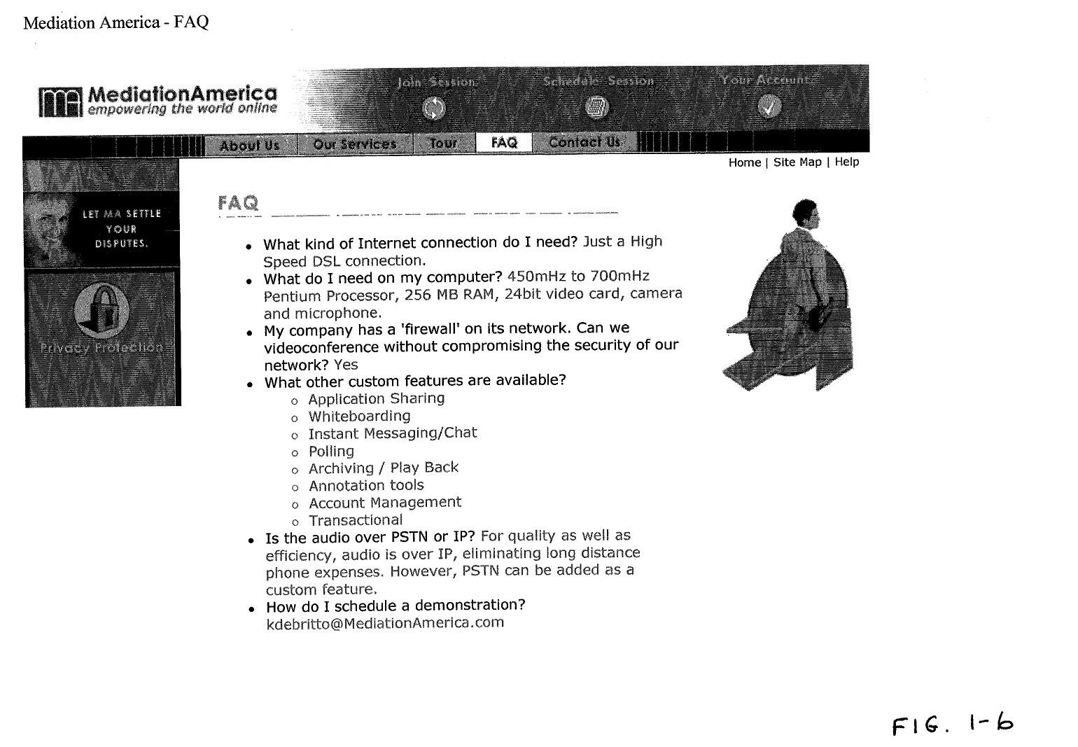

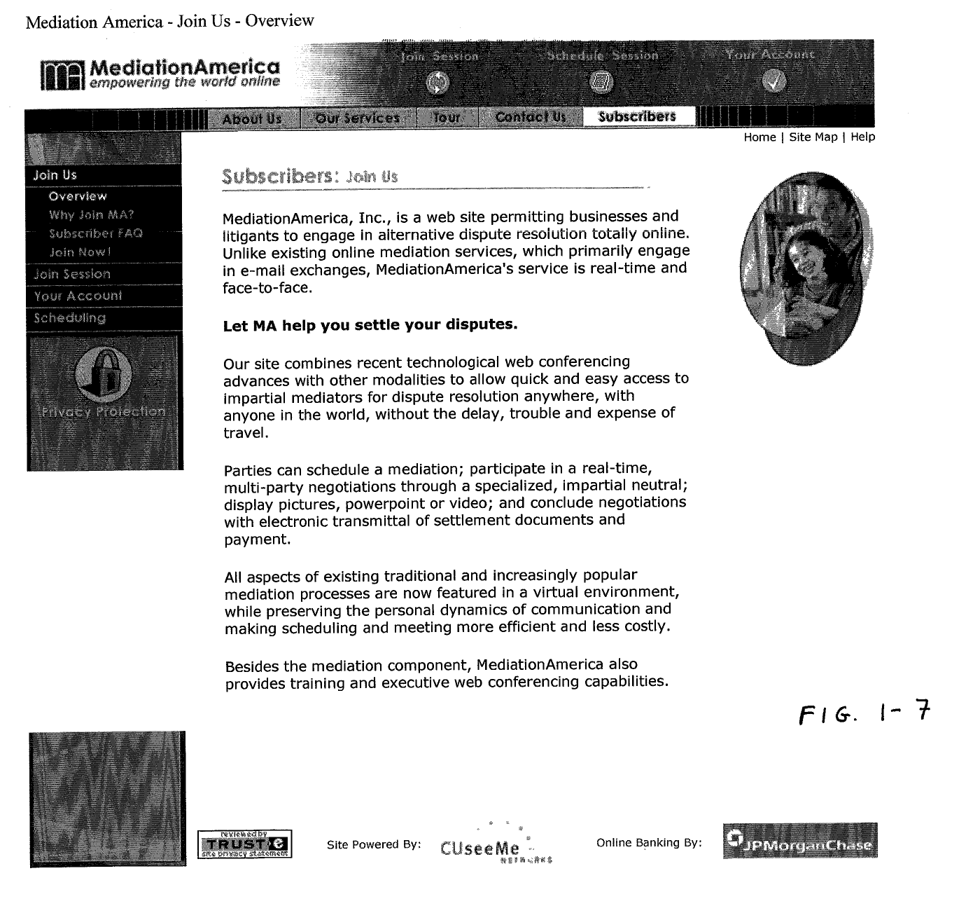

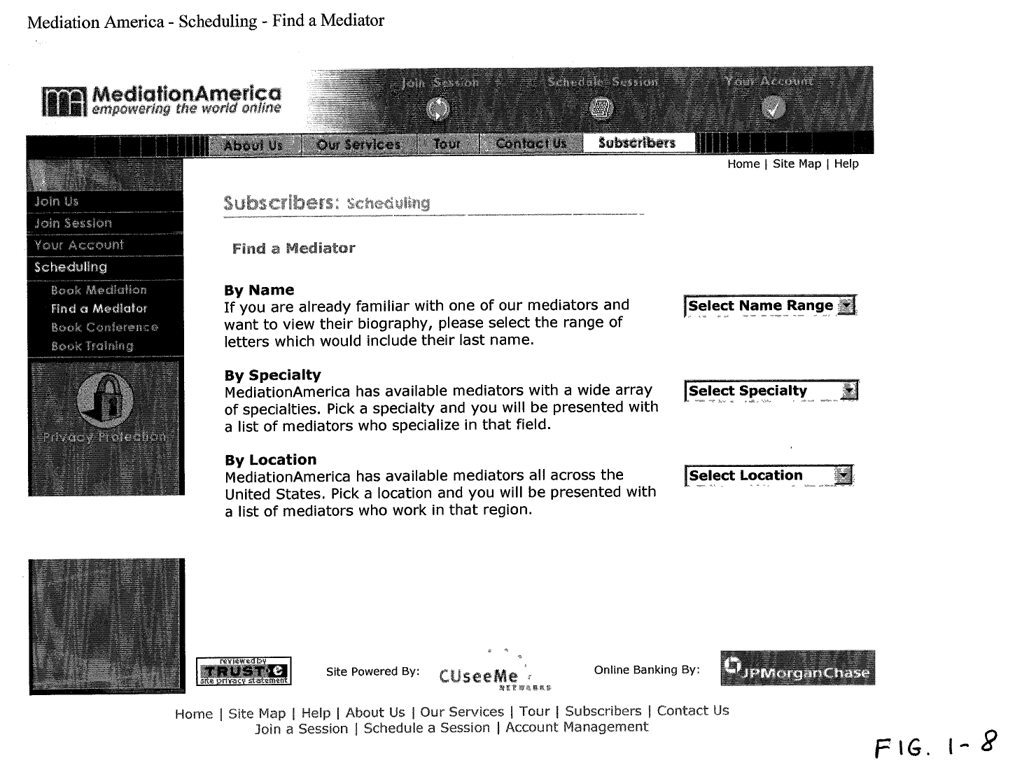

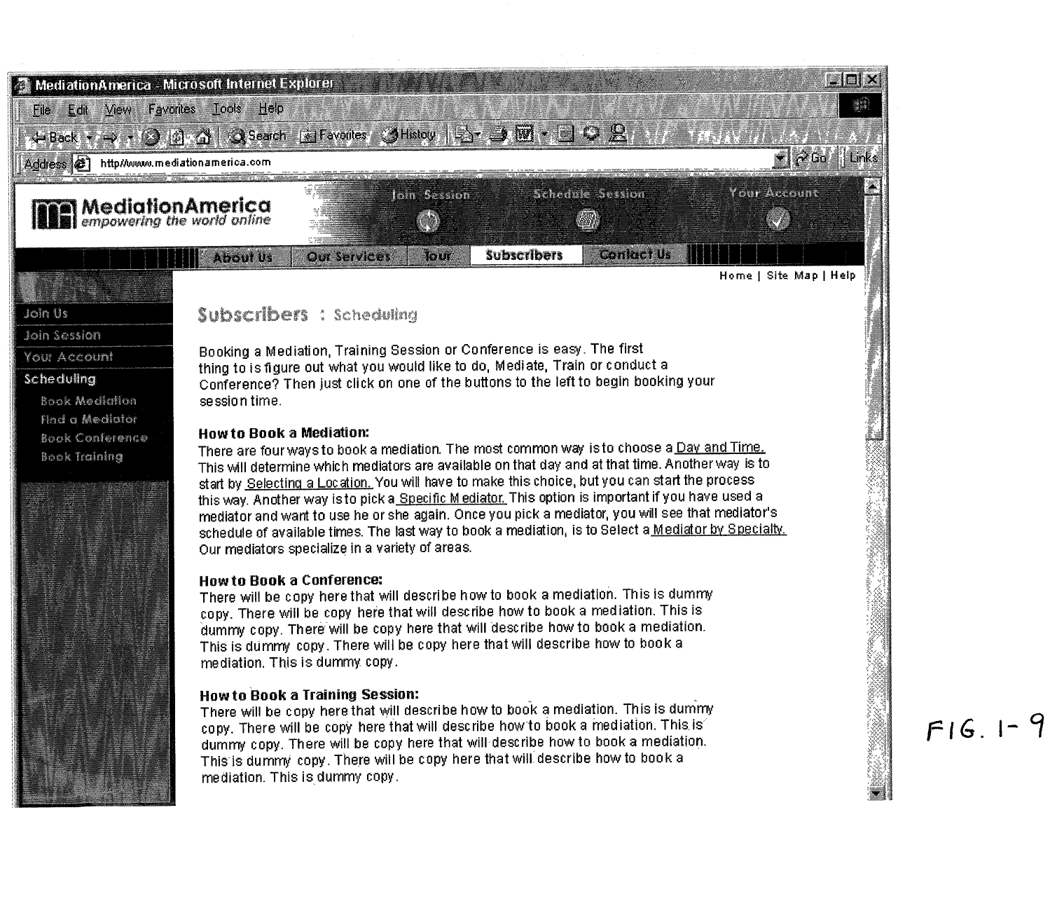

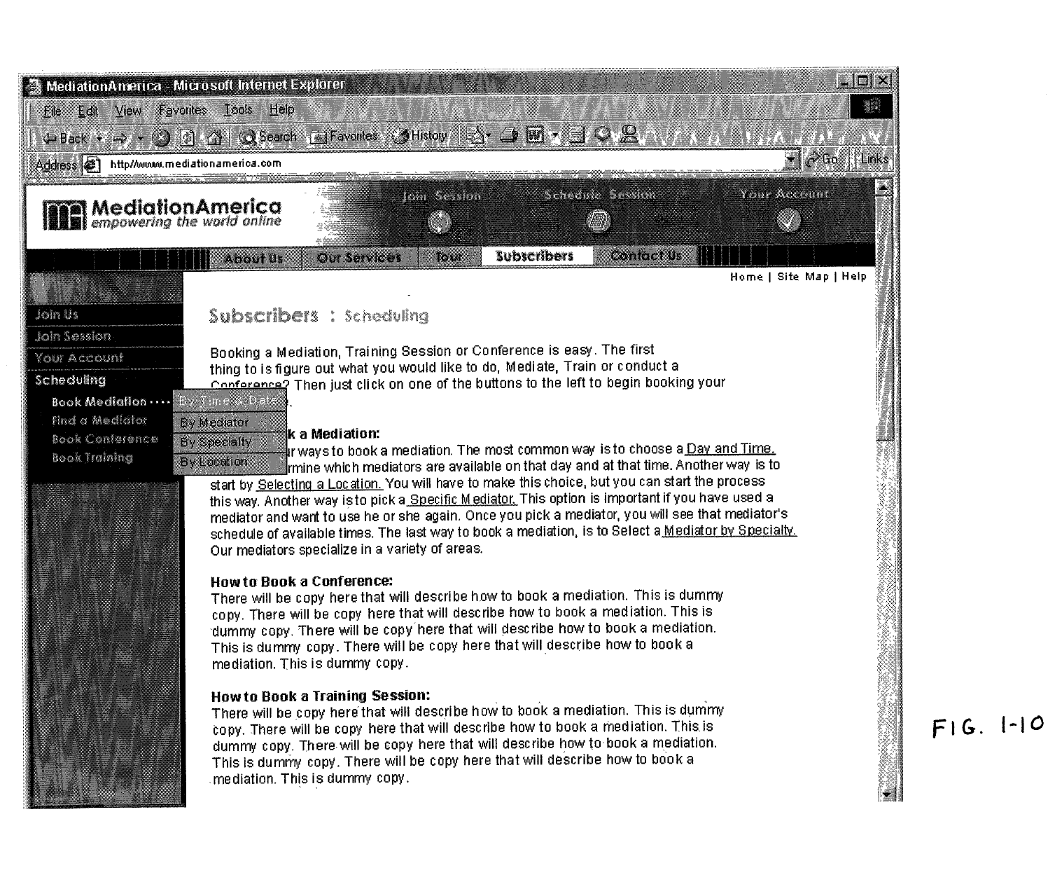

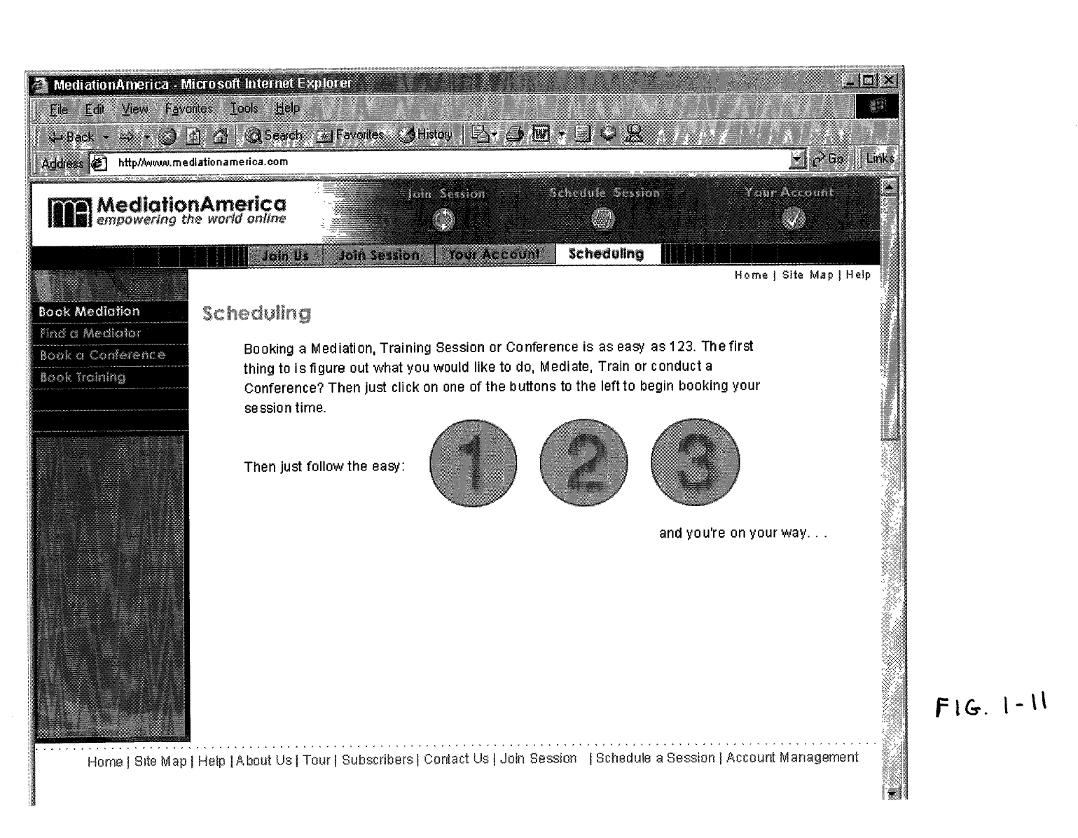

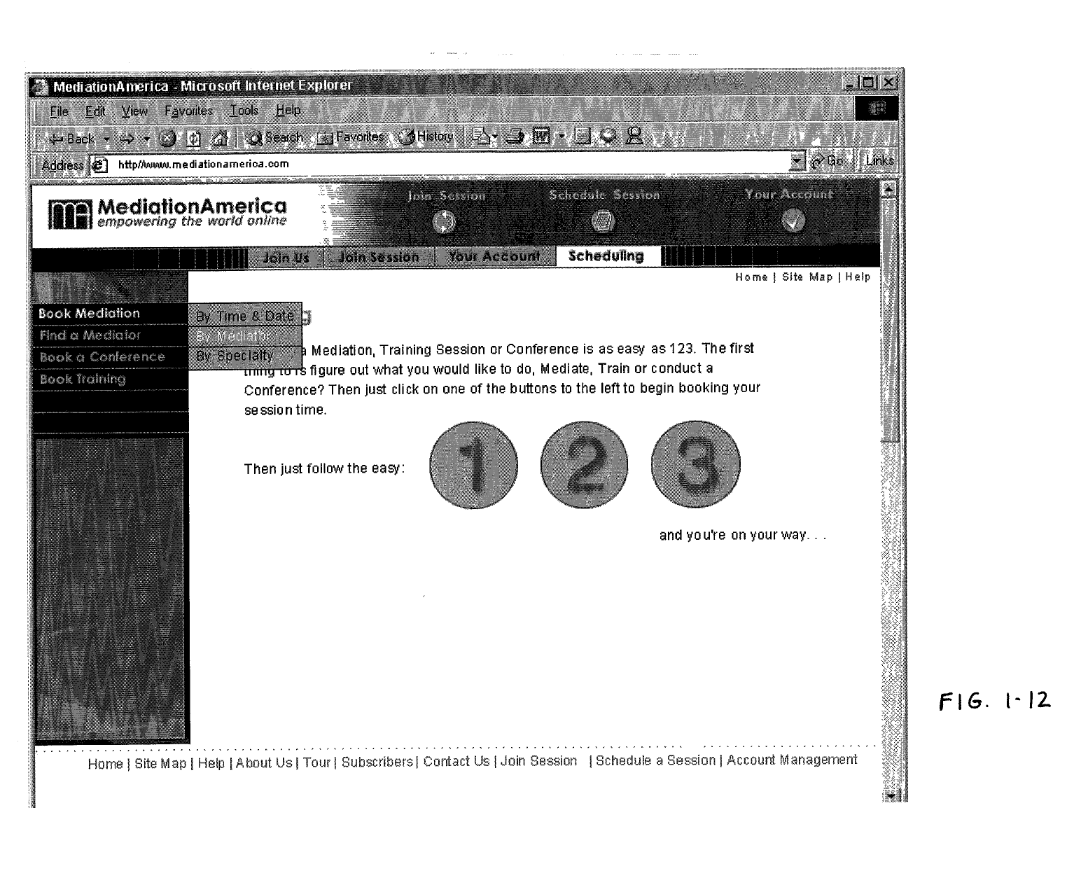

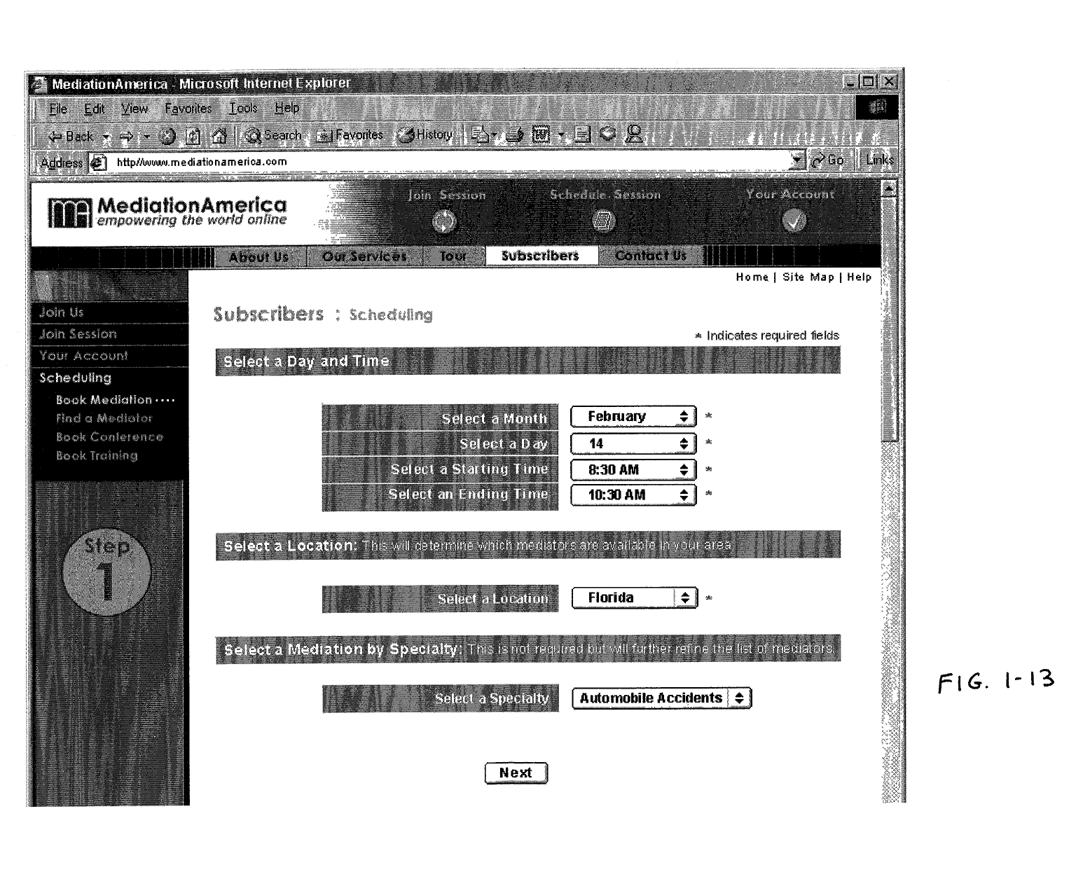

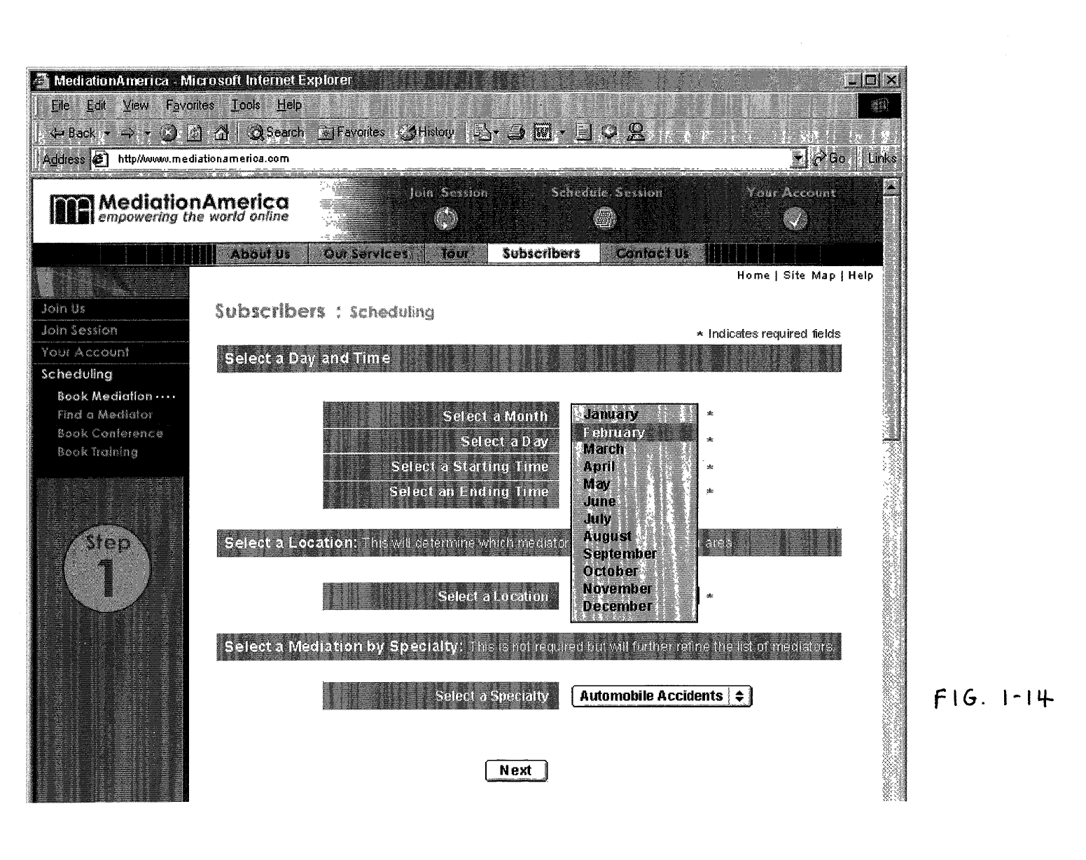

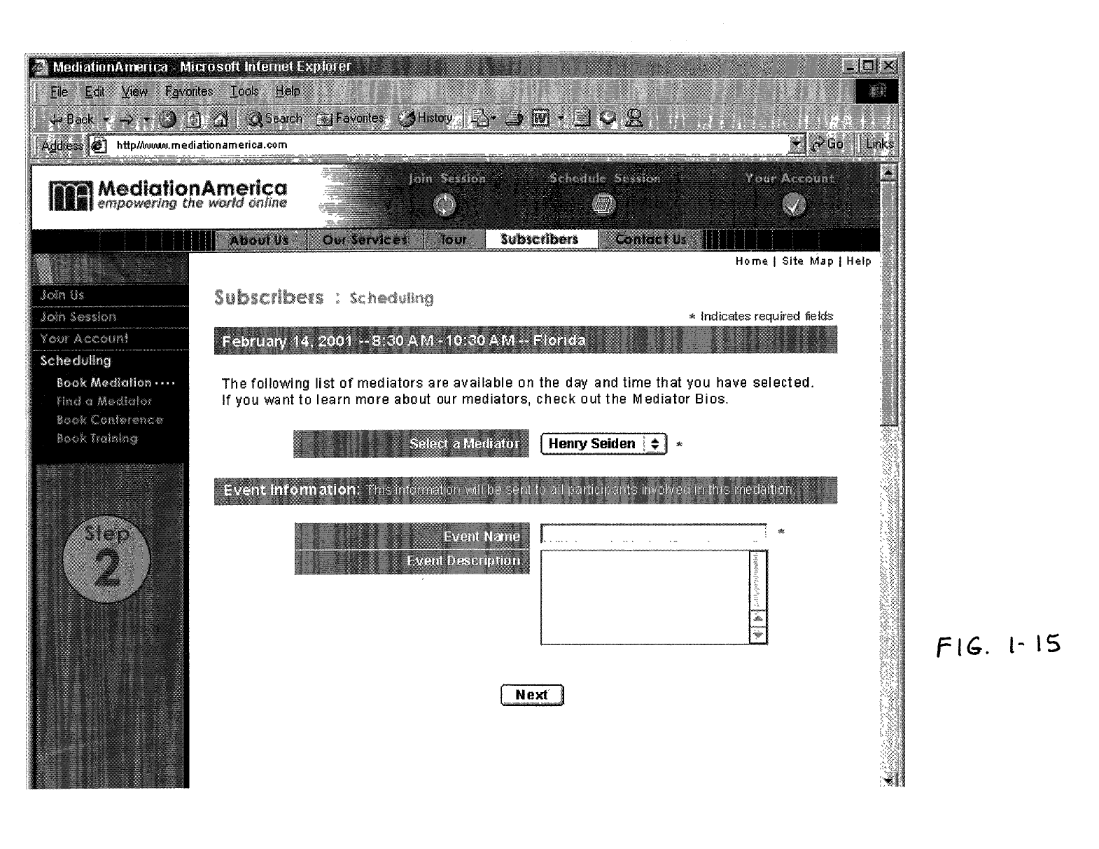

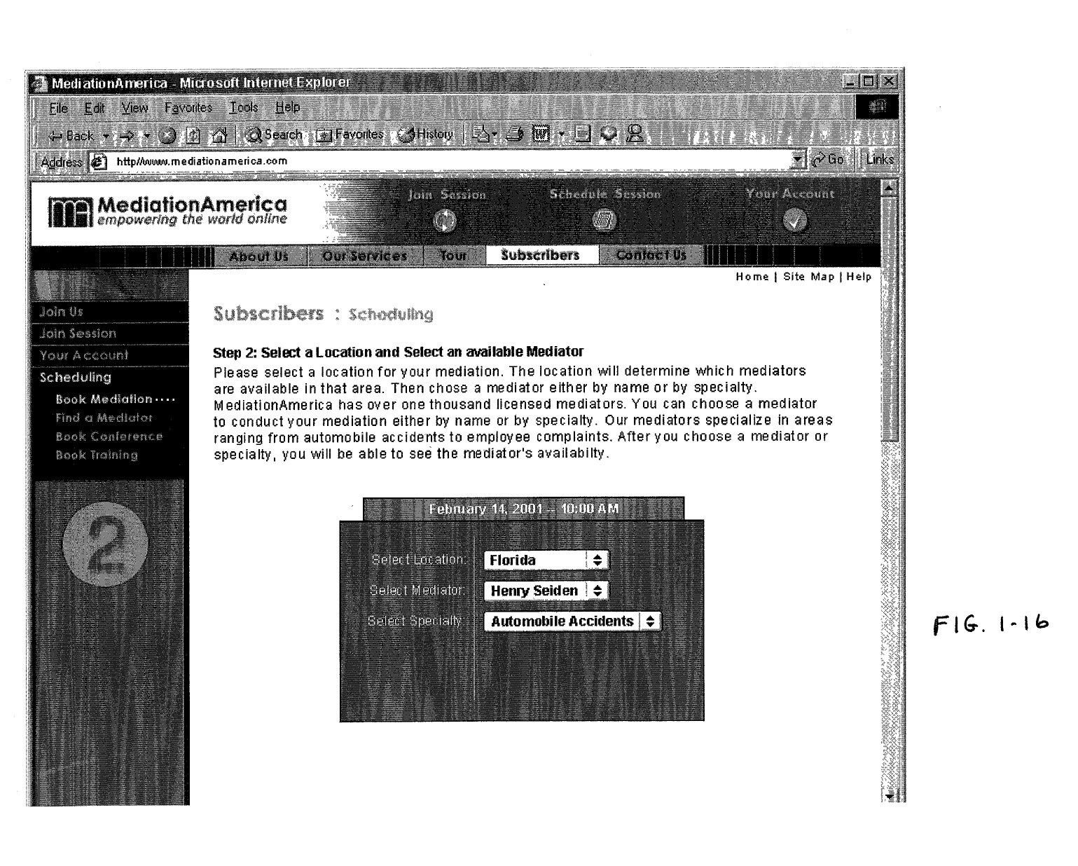

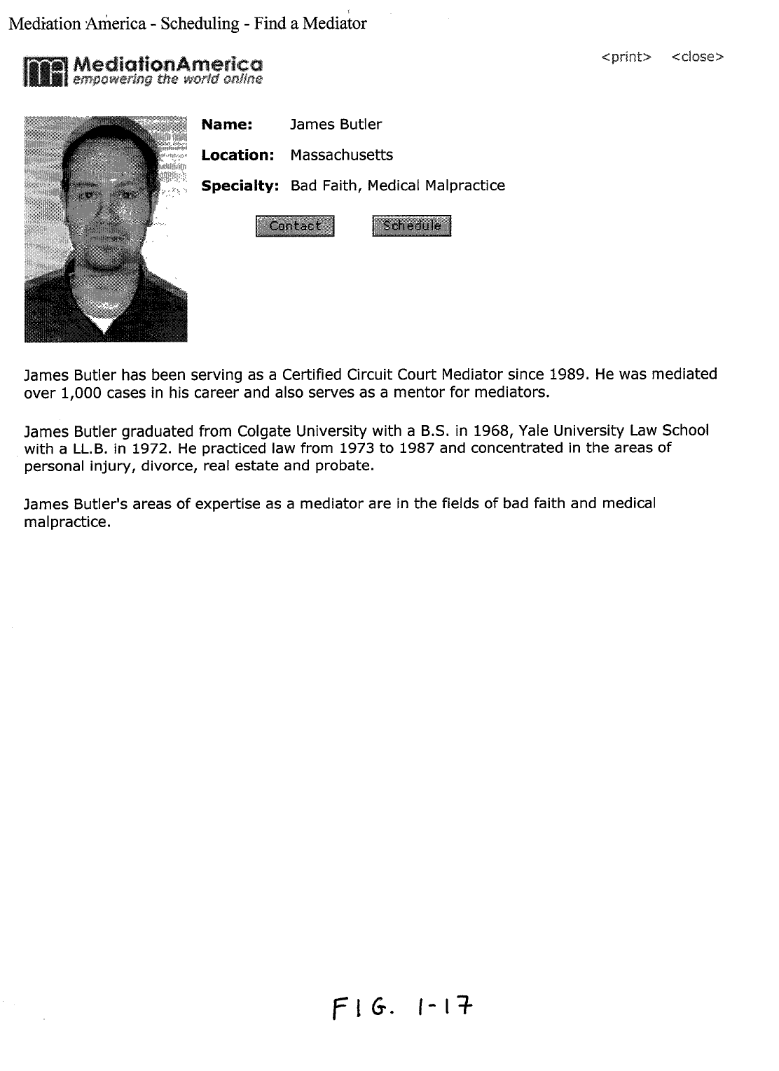

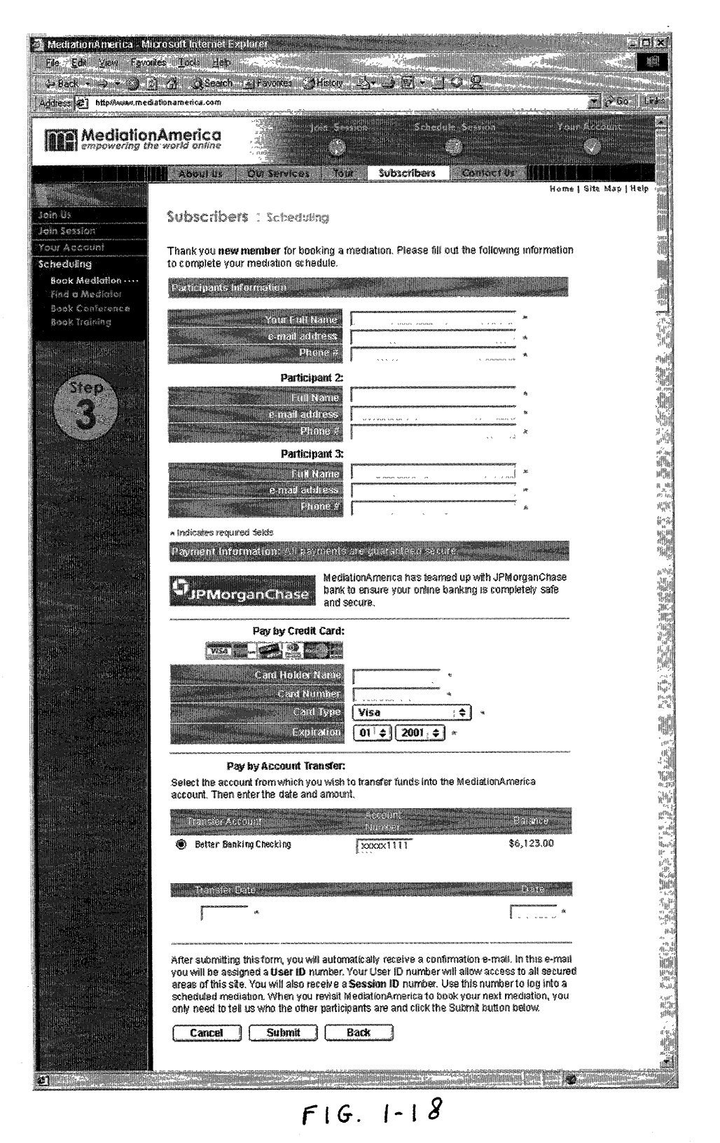

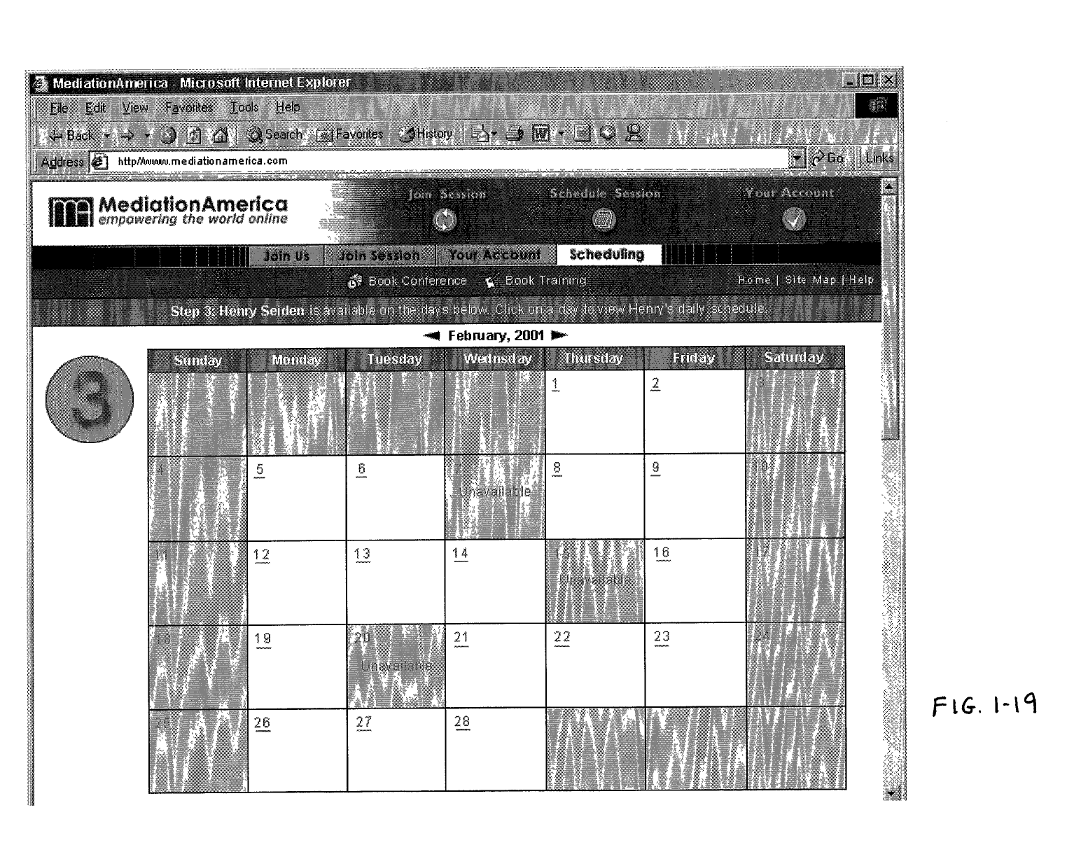

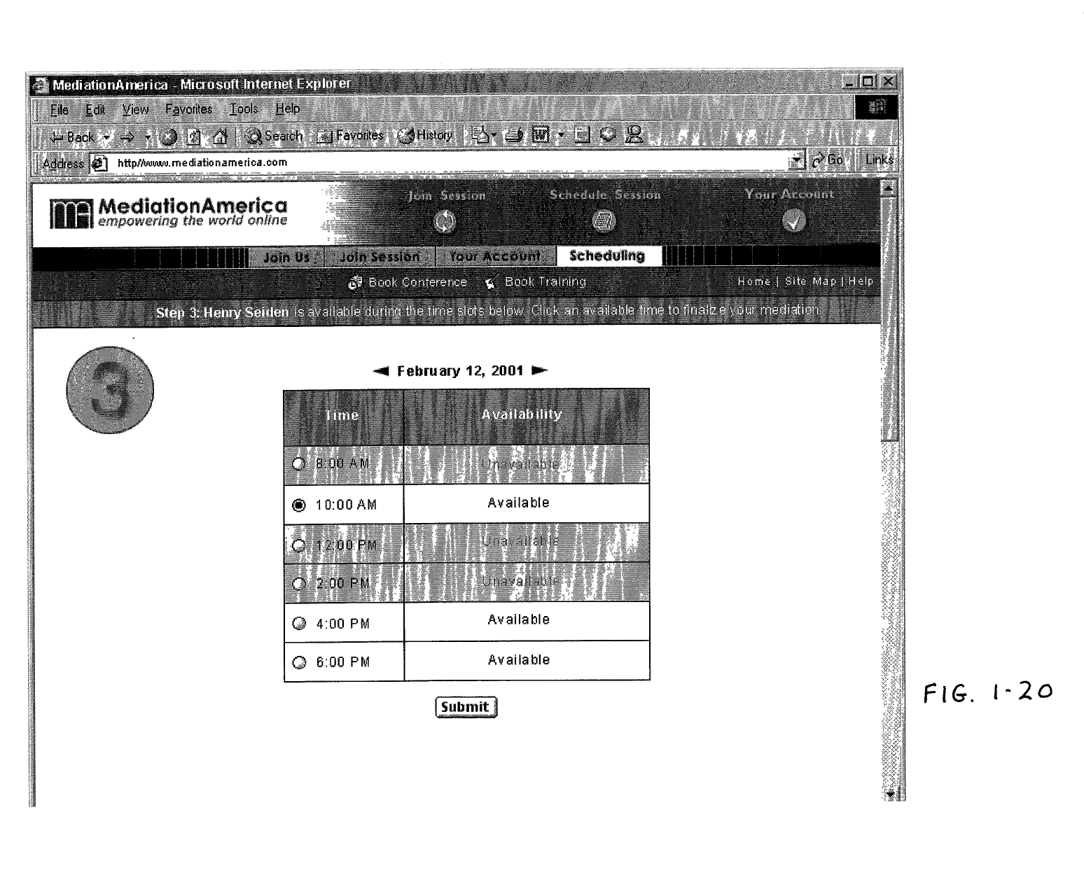

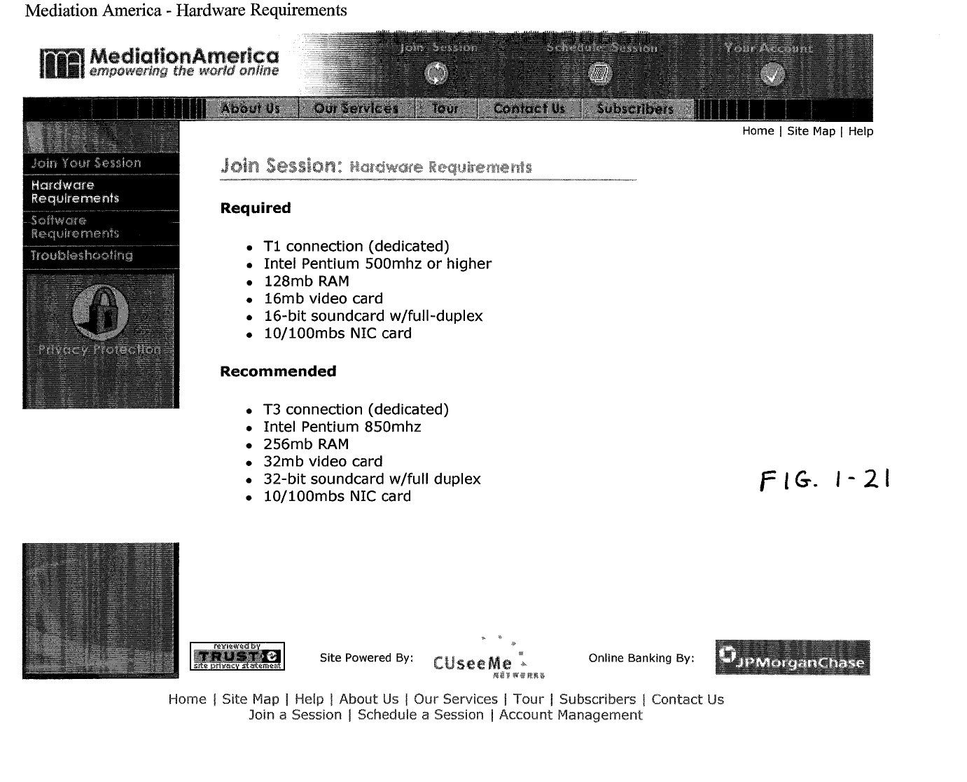

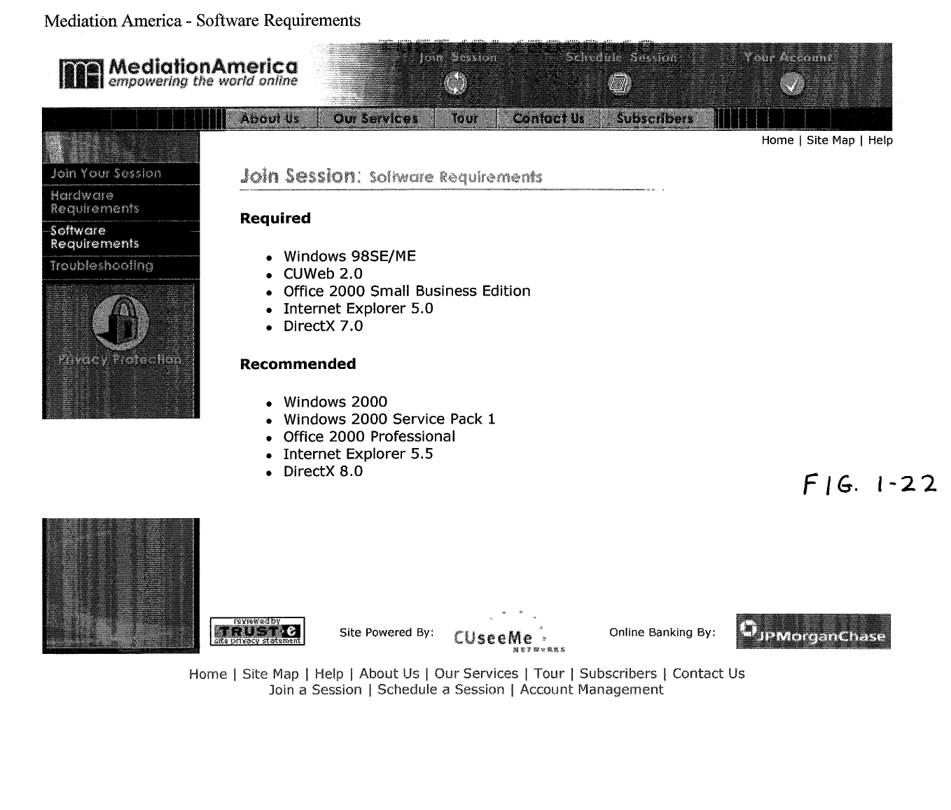

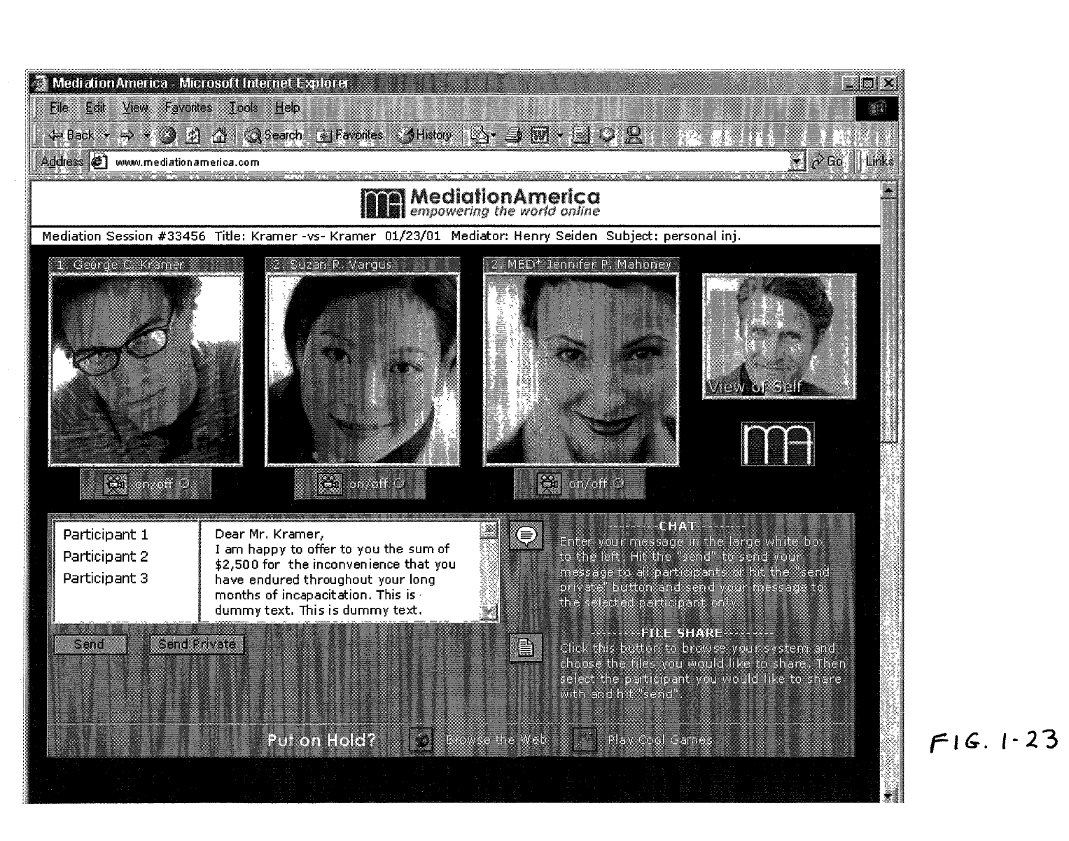

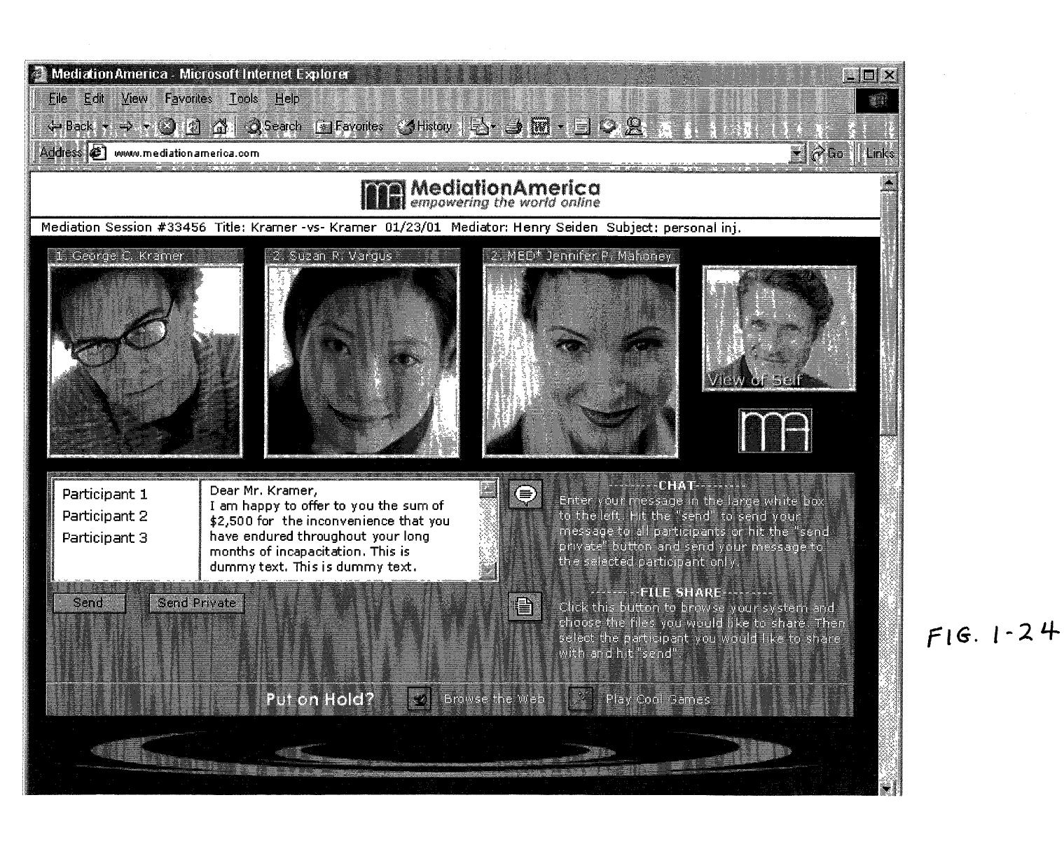

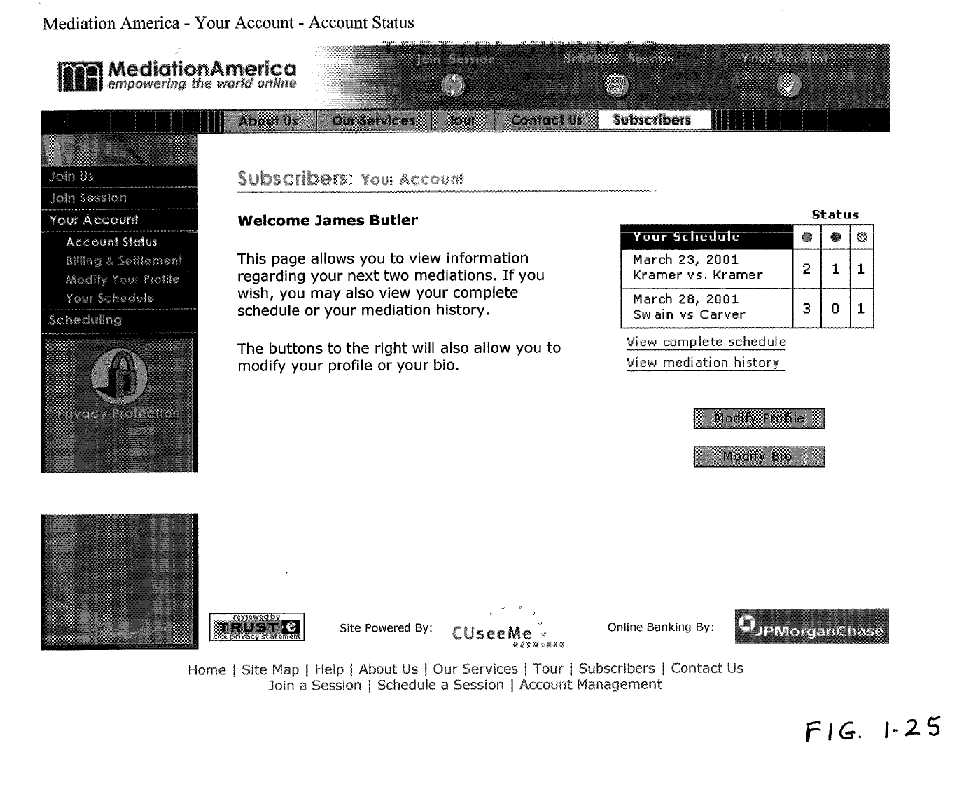

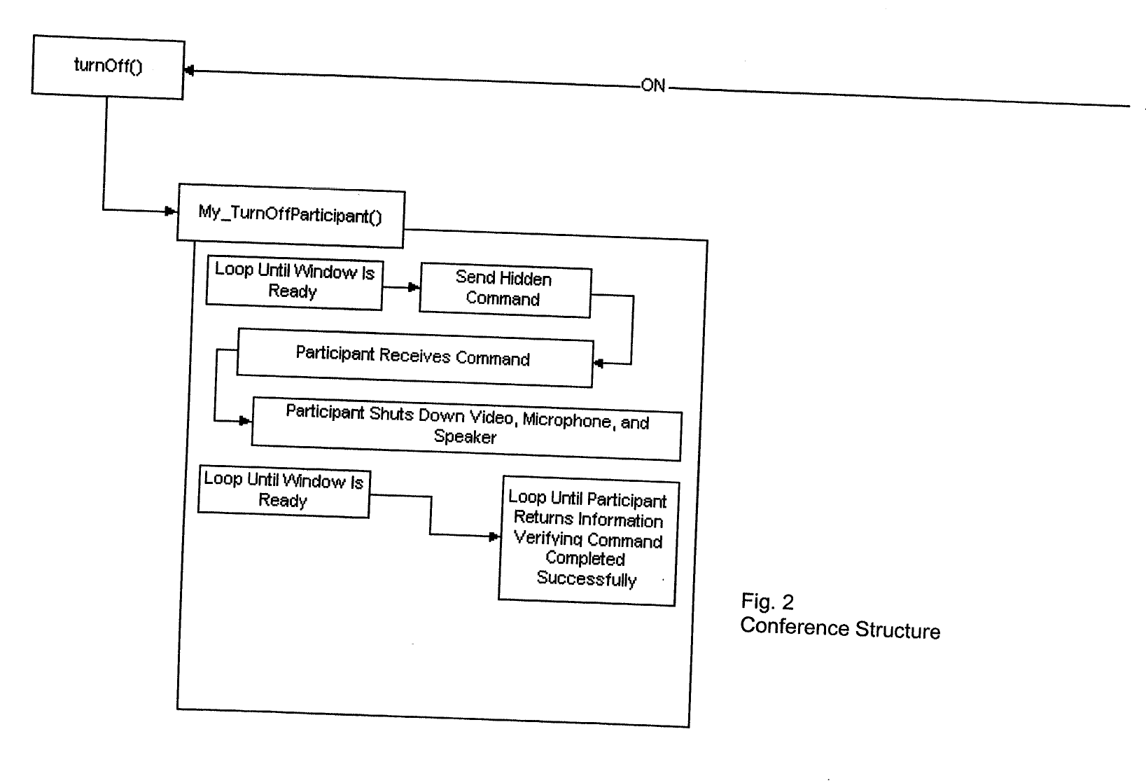

The content and functionality of the web site of the ADR method and system of the invention is illustrated in the various pages of the web site as illustrated in FIG. 1 and is described as follows:

Overview of Web Site Content

The content may include the following exemplary content:

Company description—A short description of the mediation process as it occurs using the system.

Detailed mediation description—Several paragraphs describing the mediation process in detail.

Software demonstration—a self-running demonstration of the mediation functions.

Contact us—for general information, about training courses and how to become a mediator and to become a subscriber.

On-line help—allows any participant to view a help function that describes any of the system functions in lay terms. A table of contents at the beginning and an index at the end provide hyperlink functionality to key information.

FAQ—a list of frequently asked questions is structured similar to the help function including a list of questions hyper linked to the answer and an index at the end containing hyper linked key words.

Login—For subscribers, mediators and students, each secure entry of user ID and password will check server-based database to assure validity.

Schedule Functions (Reguiring Login)

Find A Mediator By Name Or By Specialty—This is a search function that allows a user to enter one or more letters of last name whereupon the system returns list of mediators whose names match typed letters. A specialty may be selected from a drop down list, and the system will display a list of mediators who work in that specialty. Once a list is displayed, the user may select a mediator whereupon that mediator's calendar is displayed (see below).

Look For Open Date/Time For A Specific Mediator/Trainer—Once a mediator is selected, their calendar is displayed in graphic format showing the hours that are available for the current week. The user has the option to move forward or backward a week at a time.

Look For Open Date/Time For A Group Of Mediators/Trainers In A Specialty—In searching for a mediator, the user may select a specialty rather than a specific mediator by name. Once a specialty is selected, the calendars for all mediators of that specialty are displayed in graphic format showing the hours that are available for the current week. If there are more than five mediators in the group, then calendars for the first five will be displayed, and sequential links will be used to display the next five. The user has the option to move forward or backward a week at a time; the system will display all new calendars for all members of the group for each week moved forward or backward by the user.

Book An Open Date/Time For A Mediator/Trainer—Users may book a time slot by selecting start and end times and entering the required demographic and billing information for the participating parties. The system initiates the billing process for the number of hours booked. At the confirmation of the billing process, the system confirms the booking by changing the display to the review schedule display with the newly booked mediation showing. The system also displays the ID and password that has been assigned for the session.

Student/Participant Looks For An Open Date/Time For A Class—A student may display a list of classes available. Once a class is selected, the calendars for all trainers of that class are displayed in graphic format showing the hours that are available for the current week. The user has the option to move forward or backward a week at a time; the system will display all new calendars for all trainers each week moved forward or backward by the user.

Student/Participant Books An Open Date/Time For A Class—Users may book time slots by selecting them on the screen. The display of the selected class indicates the number of hours that must be booked to complete the class. When the user completes the selection process, the system confirms that the requisite number of time slots has been selected and initiates the billing process for the number of hours booked. At the confirmation of the billing process, the system e-mails the receipt information including the class schedule.

System Initiates Billing At Time Of Class/Session Confirmation—The system displays information about the course including the total dollar amount required for the class scheduled and the number of hours booked. The system gives the user the option of transferring funds with an on-line bank or paying with a credit card. Once the transaction has been completed, the system e-mails the receipt information including the class schedule.

System Initiates Billing At Time Of Mediation Booking & Confirmation—The system displays the total dollar amount required for the mediator scheduled and the number of hours booked. The system gives the user the option of transferring funds with an on-line bank or paying with a credit card. Once the transaction has been completed, the system the system e-mails the receipt information including the class schedule.

Cancel A Mediation, Class Or Conferencing Session And Notify Parties By Subscribers/Students Or By Administrators—The Subscriber or student may display current scheduled times for mediation or for class. Only mediations or classes for that person logged-on are displayed. The user selects the item to cancel, and the system displays a confirmation message. After the user confirms the deletion, the system marks the item as canceled in the system so that future inquiries will show the time as available. The system also e-mails the cancellation information and indicates that a credit will be forthcoming. An e-mail notification is sent from the system to the Administrator that a credit is required. Administrators may also display current scheduled times for a mediator or trainer. The user selects the item to cancel, and the system displays a confirmation message. After the user confirms the deletion, the system marks the item as canceled in the system so that future inquiries will show the time as available. The system also e-mails the cancellation information. Upon confirmation of the cancellation, the system initiates the credit transaction to allow the charges to be credited back to the subscriber or student.

Extend (Reconvene) Session To Another Block Of Time—This function would normally be launched at the end of a mediation session when the parties agree that an extension of the session is required. The mediator's calendar is displayed in graphic format showing the hours that are available for the current week. The user has the option to move forward or backward a week at a time. The user may book a time slot by selecting start and end times and confirming the demographic and billing information for the participating parties; these data need not be reentered, since it is a continuation of a current session. The system initiates the billing process for the number of hours booked. At the confirmation of the billing process, the system confirms the booking by changing the display to the review schedule display with the newly booked mediation showing.

Review Schedule—Subscribers may display all booked sessions for the logged in subscriber in list format. List shows all detail for each session. Mediators may also display all booked sessions for the logged in mediator in graphic calendar format. Booked sessions will be displayed as links, which will open a page showing the details of the booked session. Administrators may either select a mediator and display the same calendar described above or may display an aggregate calendar. The aggregate graphic calendar will display the number of sessions scheduled for each hourly block. The number of sessions will be displayed as a link, which will open a page showing the details of the booked sessions. Finally, students may display all booked courses for the student in list format.

Mediation Functions (Requiring Login)

Participant Logs Into A Specific Session—After a participant logs into the system, the participant enters the ID and password for the session, which was assigned when the session was booked. The system establishes its default configuration for the session; the number of onscreen windows is equal to the number of booked subscribers plus one window for the mediator. Thus, for a typical mediation consisting of two parties at diverse locations, three on-screen widows will be displayed—one for the Mediator plus two windows for the respective two participants. Mediation may begin when all parties have connected.

Mediator Turns Audio/Visual Off Or On—The mediator controls the video cameras and audio of each participant. Preferably, video and audio cannot be controlled separately. When the mediator turns off the video/audio of a subscriber: (1) the subscriber whose camera is off sees the games screen, and (2) the screens of the other subscribers show one fewer window than they did before.

Scan And Transmit A Document Or Photograph—This function is provided through fax or scan capabilities and using the file upload tool within the session interface. Each subscribing party may be provided a fax machine or scanner as a part of the configured hardware.

Display A PowerPoint Presentation—The mediator controls the ability for any party to present a PowerPoint presentation. When the party is given control, all screens preferably display only the presentation being shown.

Display A Video—Using the video functionality of PowerPoint, any party may present digitized video to the other parties.

Pan, Tilt And Zoom My Camera—This function will be a hardware process. Depending upon the video hardware selected, it is anticipated that the camera may be controlled to automatically to point to speakers. No software camera control will be provided.

Participant Sends An Instant Message To One Or More Other Participants—At any point in the process, including when the games screen is displayed, a participant may send an instant-private-secure message to one or more other participants.

Extend (Reconvene) Session To Another Block Of Time—This function would normally be launched at the end of a mediation session when the parties agree that an extension of the session is required. The mediator's calendar is displayed in graphic format showing the hours that are available for the current week. The user has the option to move forward or backward a week at a time. The user may book a time slot by selecting start and end times and confirming the demographic and billing information for the participating parties (this data need not be re-entered, since it is a continuation of a current session). The system initiates the billing process for the number of hours booked. At the confirmation of the billing process, the system confirms the booking by changing the display to the review schedule display with the newly booked mediation showing.

Settlement Functions—(Requiring Login)

Subscriber Creates Settlement Document, Release Document or a Dismissal Document—A settlement, release and/or dismissal document may be created by the subscriber either as a handwritten document to be faxed or scanned or a text document via word processing software, which may be transferred using the File Upload tool. Templates for standard documents may be provided. Transmission to the other parties in the mediation may be via fax machine, scanner, e-mail or using the file upload tool.

Subscriber Initiates Funds Transfer Via On-line Bank or Clearinghouse—The subscriber may initiate a funds transfer or credit card payment upon confirmation of a scheduled session.

Mediators Report To Court—This document may be created by the mediator via word processing software. Templates for standard documents may be provided.

Billing Functions (Requiring Login)

Billing Is Initiated As Part Of Booking Process—The system splits fees among parties for mediation/session. As a part of the booking process, the system calculates the required charges for each subscriber. The formula for charges to each subscriber is: Hours Booked X Hourly Rate/Number Of Subscribers Participating. Fees for classes are not split, but are fixed for the class session. Fees may be paid by the scheduler in advance and not split between parties. As a part of the class booking process the fee for the class is displayed in the confirmation e-mail.

Subscriber or Student Initiates Funds Transfer Via On-line Bank or Clearinghouse—Data for the funds transfer were entered as a part of the subscriber registration/scheduling process and therefore the funds transfer may occur electronically.

Subscriber or Student Initiates Credit Card Transaction For Payment—Data for the credit card transaction were entered as a part of the subscriber registration/scheduling process and therefore the charge to credit may occur electronically.

Mediator Completes Report To The Administrator—Upon request, a form may be provided to allow the mediator to prepare a report covering the resolution of the mediation. The form will be built with subscriber information already filled in. Typical answers will be pre-coded, and fill-inthe-blank will be used for additional information.

Administrator Initiates Funds Transfer Via On-line Bank or Clearinghouse or Credit Card Transaction For Credits—Administrator may select the subscriber and mediation ID and password or student and class to receive the credit. Data for the funds transfer were entered as a part of the registration process.

Administrator Initiates Funds Transfer Via Virtual Bank/Clearinghouse To Pay Mediator—Data for the funds transfer were entered as a part of the registration/scheduling process and therefore the funds transfer may occur electronically.

Other Functions Subscriber Reviews A Mediator's Bio—Once the subscriber has selected a mediator, it is possible to view the mediator's biographic information on the system.

Link To Mediator's Calendar—The subscriber may branch to the mediator's calendar from the mediator's bio page.

Pastime While Video/Audio Is Disconnected—Pastimes may be provided to allow people to pass the time while their video/audio is disconnected. For example, a link to a web site containing games may be provided that people may play while their audio and video is disconnected.

Training Functions (Requiring Login)

Display list and description of on-line courses available—once a student has logged on, they will be able to view a list of courses available in the web site content areas. The list of courses will include course title, prerequisites, and list of instructors as directed.

Student books course via the scheduling function.

Maintenance Functions (Requiring Login)

Registration And Profile Maintenance—Mediators, students, and subscribers may register through the on-line registration function. The function provides information about registration and allows the user to type information into the blanks on the form. Forgotten passwords will require that the user contact the administrator to retrieve their password. An appropriate security code will be carried in the database to confirm a user's identity.

Mediator Maintains Schedule; Block Dates/Times—Mediators have the ability to control their calendar by blocking out the dates and times that they are available for mediation. Once logged onto the system, the mediator selects the calendaring function and displays their calendar a week at a time. At this point either weeks may be added to the schedule or current weeks may be modified. As weeks are added to the schedule, they are built in the default format, which may then be modified. An option exists for the mediator to change the default schedule for their normal week. Modification to schedules for individual weeks are made by selecting starting and ending times and specifying that these times are not available. Mediator schedules may be built to for up to one year in the future.

Trainer Maintains Schedule Of Courses; Blocks Dates/Times—Trainers maintain their schedule of courses by using a calendar function similar to a mediation calendar. Once logged onto the system, the trainer selects the scheduling function and displays their calendar a week at a time. At this point either weeks may be added to the schedule or current weeks may be modified as weeks are added to the schedule they are built in the default format, which may then be modified. An option exists for the trainer to change the default schedule for their normal week. Modifications to schedules for individual weeks are made by selecting starting and ending times and specifying which course is scheduled for that time.

Mediator Maintains Data—Once the user has logged in and selects the maintenance function they are brought to the maintenance screen that allows them to update their user information. Basic demographic information may be changed, but user identification and password may only be changed by administrators. Examples of data items that might be maintained for a mediator are as follows: name, password, bank account with virtual bank, contact data and biographical information.

### Web Site Design and HTML Coding

The preferred embodiment of the interface of the web site of the ADR method and system of the present invention is designed for growth with room for expansion including room for more buttons across the top and at the left for expansion. The interface is designed for speed with no rich, heavy graphics or gradients. DHTML is used in certain areas to reduce the number of clicks users need to navigate the web site. The quick access icons across the top are a good use of DHTML (e.g., a scheduled mediation becomes one click away). The Scheduling Overview page uses DHTML when rolling over Book Mediation because the four different ways to book a mediation, training or conference session—by time and date, by location, by controller (Mediator, trainer, etc.). Rolling over Find a Mediator/Trainer also reveals a DHTML drop down menu. The header at the top of the content area indicates the major section and a specific subsection, thereby indicating where the participant is at any given time and allowing one to get anywhere from anywhere. The footer is a standard, quick access, HTML footer that serves no other purpose than to navigate when the viewer has scrolled down to the bottom of the page. The left navigation bar is very flexible. Space under the buttons is provided to accommodate any number of focus areas such as quick links to News & Events. Advertisements or banner ads and customer pulled quotes may be placed as desired.

The preferred embodiment of the Home Page is where the navigation is established and remains the same through the rest of the site. The focus areas are designed to accommodate any number of quick links or pertinent and breaking news. The quick access icons across the top are designed to be quick access to the functional sections of the site. The viewers familiar with the site may use these icons to access secured areas, jump right into a scheduled session and schedule a session.

In the preferred embodiment of the web site, the mediation tool interface, which is also the conferencing tool interface, is where the live mediations and conferencing will take place. The title bar contains the logo and all the pertinent information about the current mediation. It displays the Session #, who is involved in the mediation or conference, the date, the mediator's name and the subject of the mediation. Next to all of that information are two links that are designed to occupy a participant if be or she is temporarily turned off from the mediation. He or she may browse the web or play games.

The video widows are preferably located across the top with three of four windows the same size. The smaller window is always the view of oneself. Each widow has a title bar that displays the name of that particular participant. The mediator has a slightly different interface in that he or she has the ability to turn the audio/video of each participant on or off. In this regard, a small circular button is located on the top right corner of the video window title bar. The mediator may click this button to shut off a participant's window. The button will change from green to red.

The Instant Message button is positioned directly below the selfview video window. It will launch a pop-up window that will allow a participant to send a message to anyone in the mediation.

The file sharing takes place below the video windows in a frame set. The left frame is a list of available files to download. The right frame is where the downloaded file will display. There are three buttons associated with file sharing. Refresh will refresh the list of files. Upload will upload a selected file and delete will delete a selected file. The buttons in file sharing as well as the other elements in the mediation tool remain consistent in color size and font.

### Scheduling Process Design

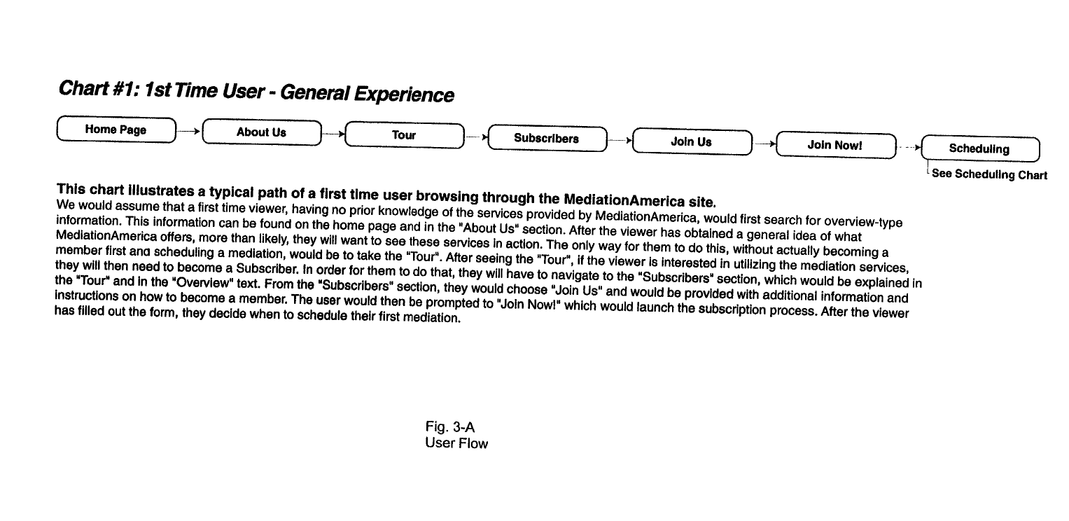

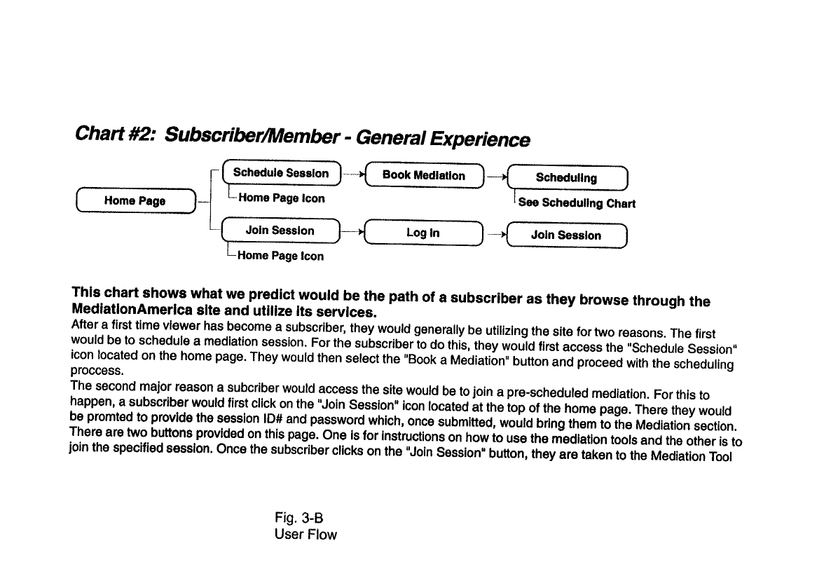

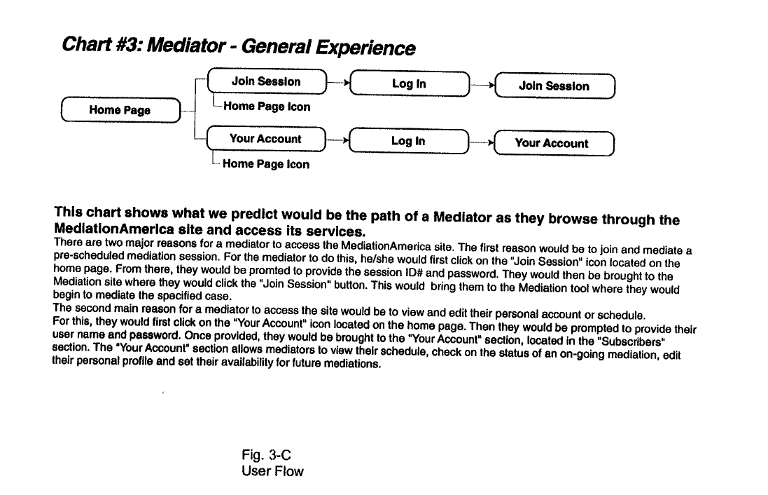

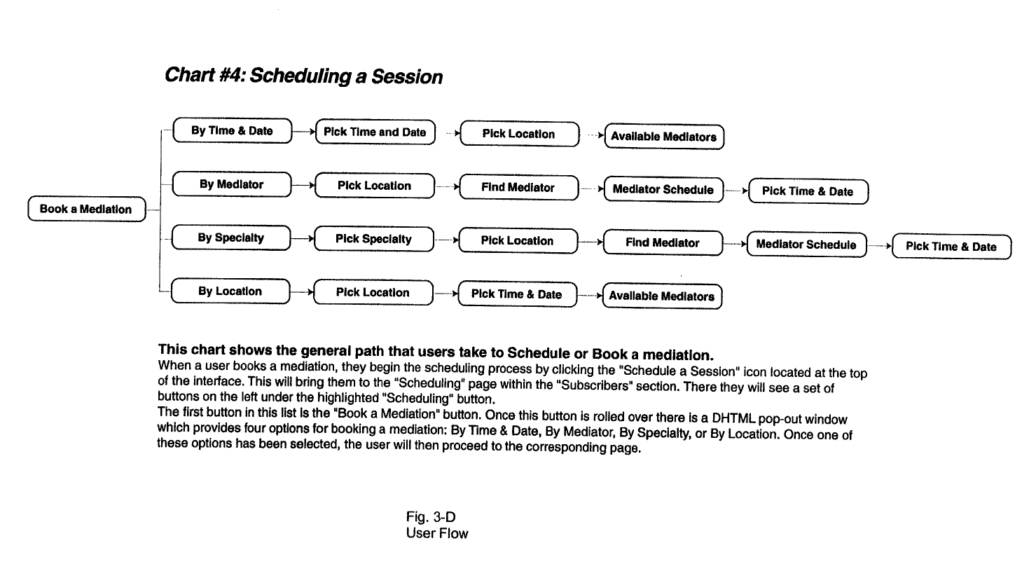

The process of scheduling a mediation, training or conferencing session is illustrated FIG. 3. Drop-down menus are preferably used to choose various categories—pick a date, pick a time, pick a mediator, trainer, etc. The elements such as the title bars and form fields used are preferably bold and very easy to read. Large icons, residing in the left hand navigation bar, are employed to help the scheduler follow the process. The icons are simply Step 1, Step 2, and Step 3.

### Site Map of The Web Site

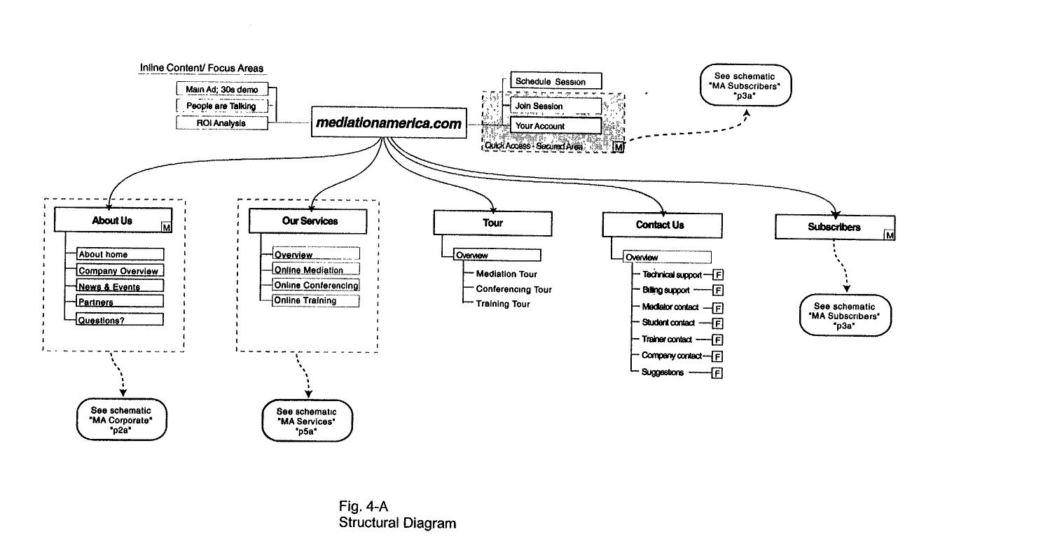

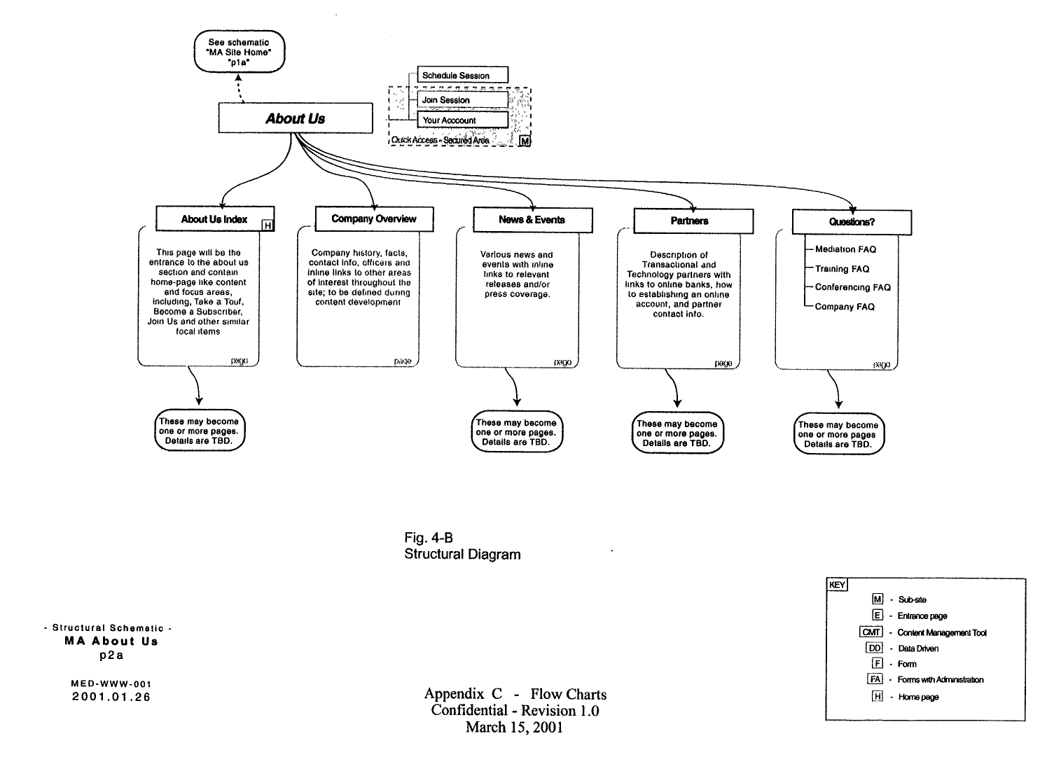

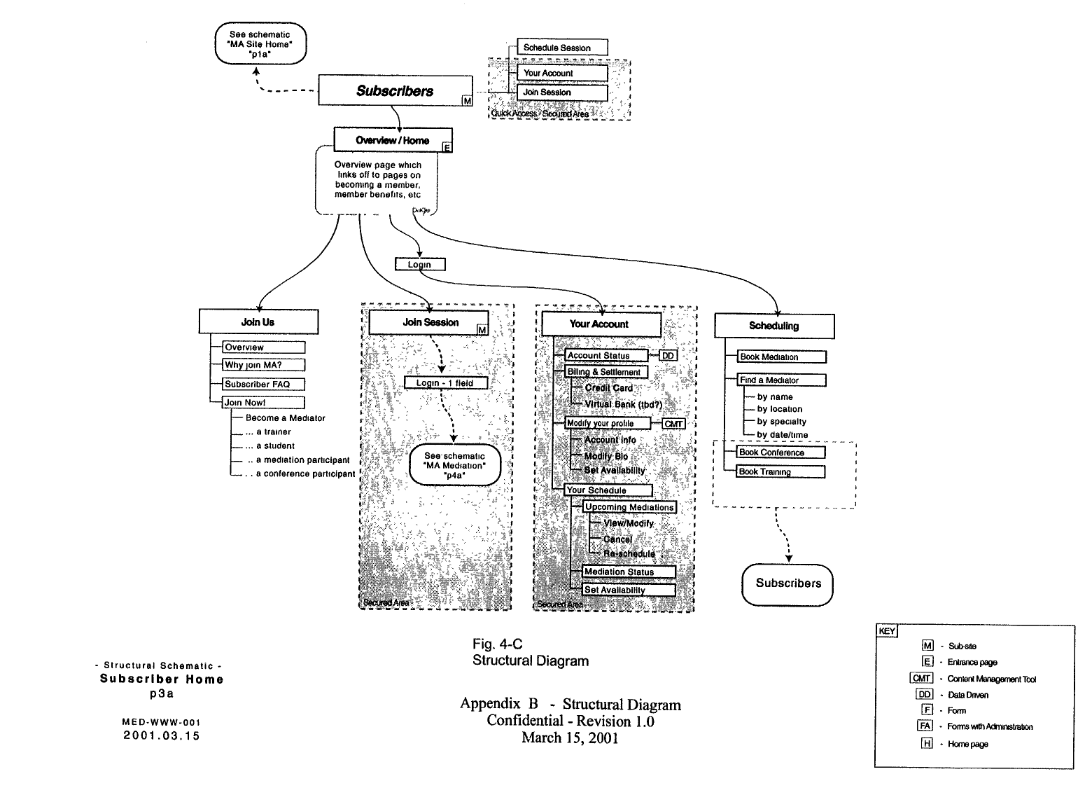

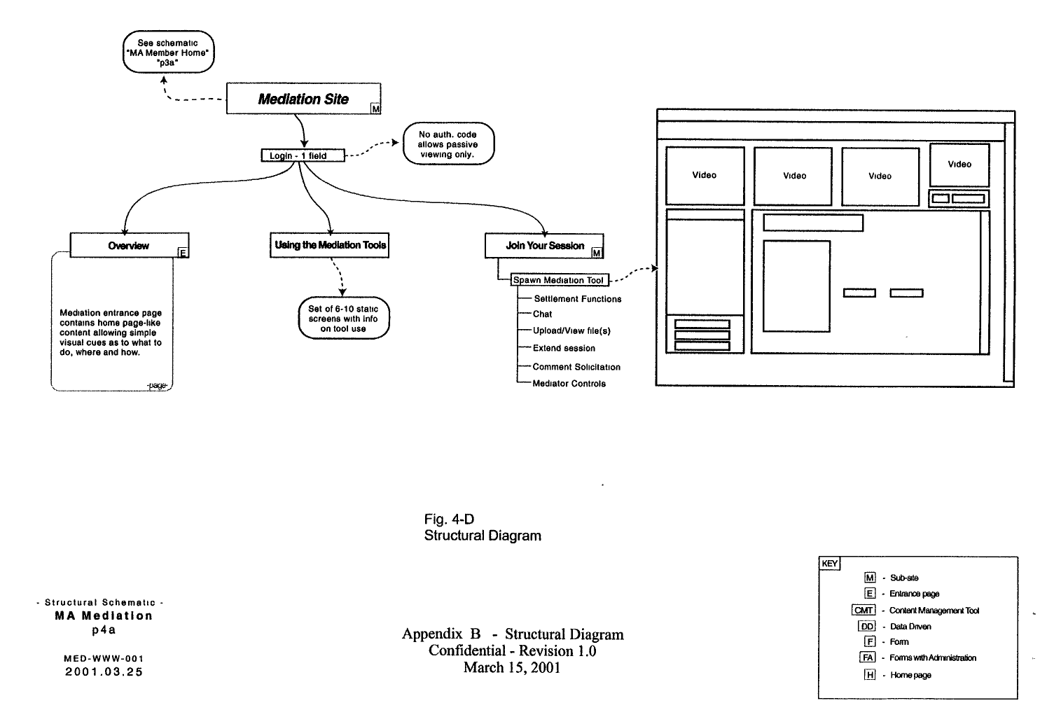

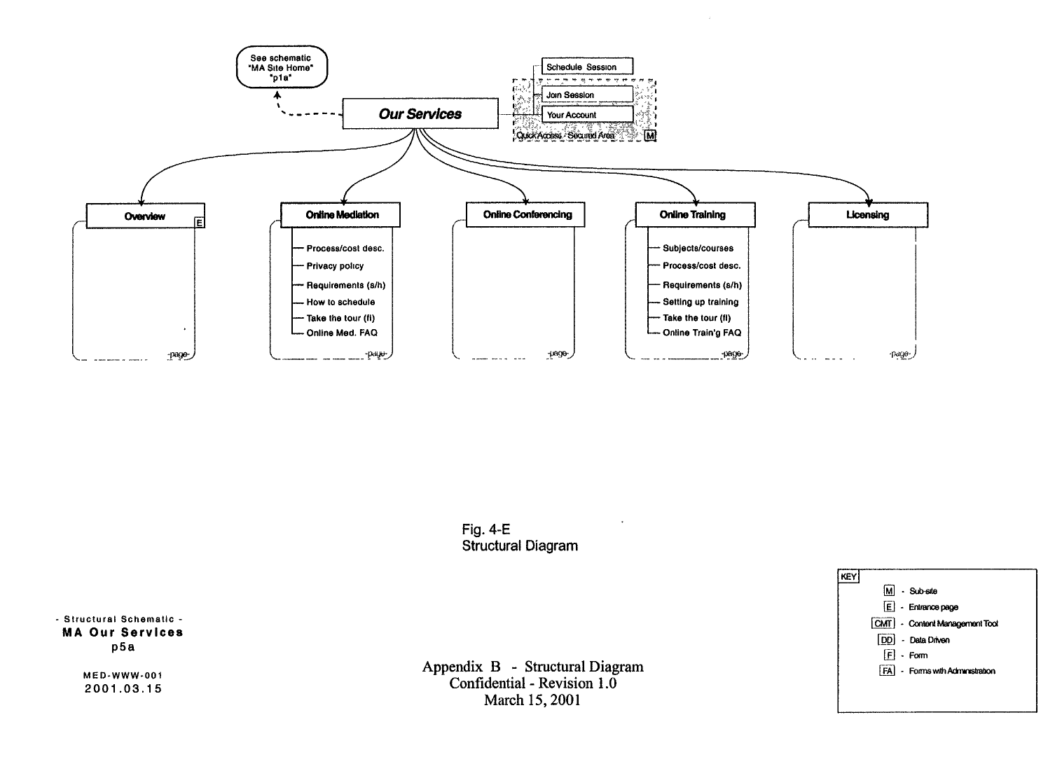

The site architecture for the web site is illustrated and described in FIG. 4.

### Customer Database and Schematic design

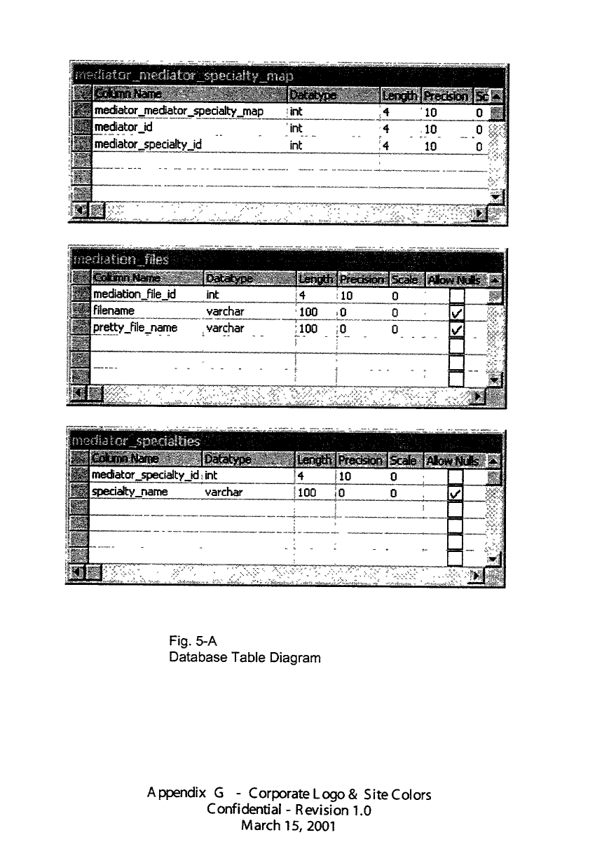

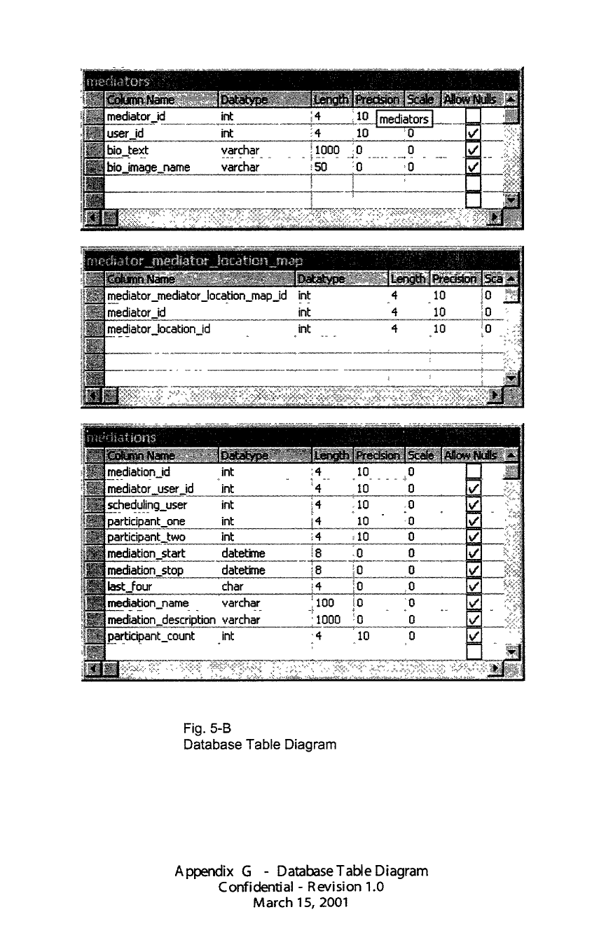

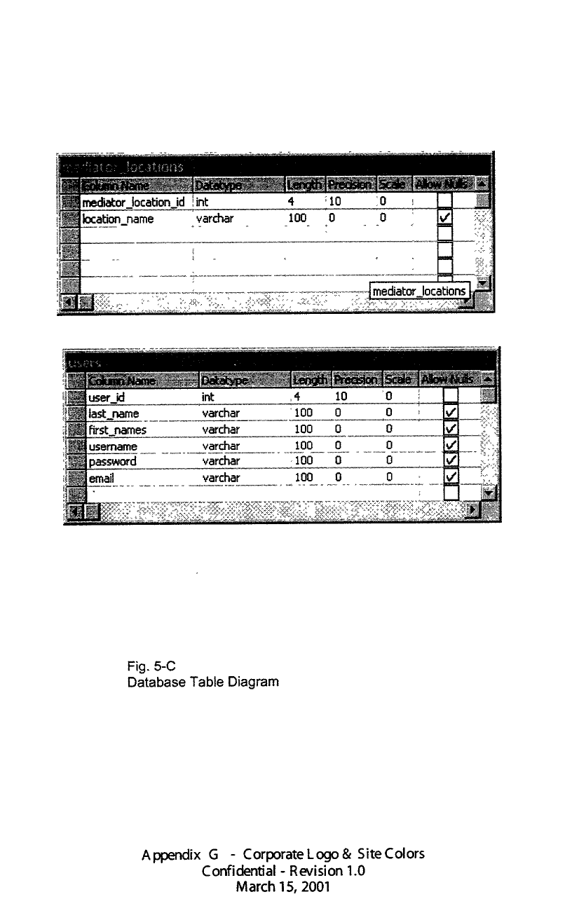

Customers may register using an approved registration form for Training, Conferencing and Mediation. The mechanism for handling the registration process is described below and is supported by the database diagram of FIG. 5. Appropriate tables according to the session type of each web site may be provided.

E-Mail Svstem The E-mail system is a scheduling and billing confirmation system based on mutual agreement of all session participants and the session controller (Mediator, Trainer, etc.). Once the session initiator schedules a session, the controller and session participants receive the first e-mail requesting a session. Upon confirmation from all parties, a unique, alphanumeric session identification and password is generated and emailed to each participant and controller. Participants are billed electronically at this time. A copy of this invoice, as well as the date and time of the session appears on this second e-mail. The preferred system used for e-mailing is Microsoft's IIS Mail Relay which runs off the web server and is part of Microsoft's Option Pack 4. The Mail Relay is a simple application that forwards mail through the system and out onto the Internet to its intended parties. The addresses themselves are pulled from the member database upon scheduling a session, inserted into a mail message (invite, confirmation, access code assignment, etc.) through ASP code (which is embedded throughout all scheduling pages) and passed to the Mail Relay for delivery out to its intended audience.

### Sign-up And Membership Information Storage Process

All members are preferably pre-enrolled in the system in order to confirm or deny invitational requests initiated through the scheduling tool. While the current preferred embodiment lacks forms time that permit a user to access a scheduled session or the mediation tool with being preenrolled, future implementations may eliminate the need for member pre-enrollment may dissipate. A set of custom forms will be designed and created to facilitate end-user driven member registration requests.

### E-commerce Modeling/Payment Solutions

All payment processing (and account management) in the final release of the product (e.g. credit card billing) may be conducted over an SSL-encrypted connection utilizing an approved clearinghouse for all purchase verification and transaction processing. On-line banking may use similar, if not identical data stream encryption as credit card processing by an on-line clearinghouse, such as JPMorganChase. Credit card information will be collected at the time that a mediation, conferencing or training session is scheduled. To make sure that this sensitive information stays private, this information will only be sent over an SSL (Secure Sockets Layer) data stream-encrypted connection.

### System Architecture (Tier-by-tier)

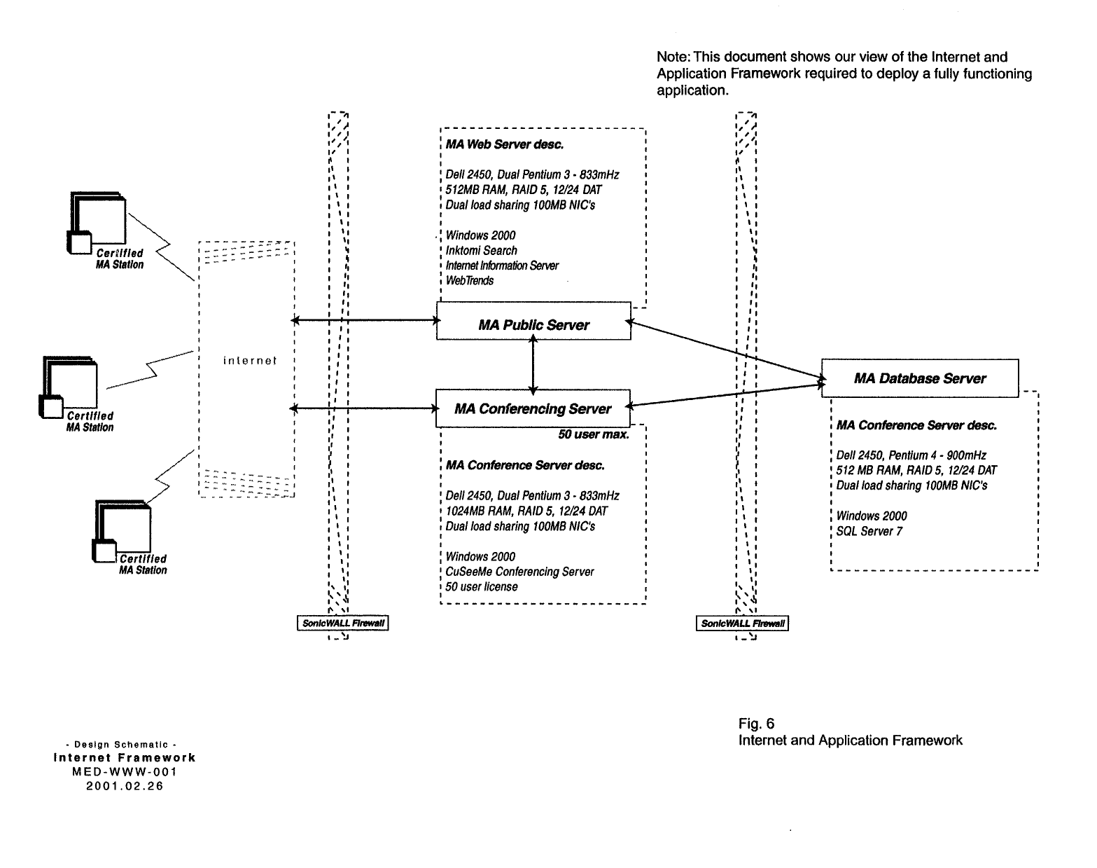

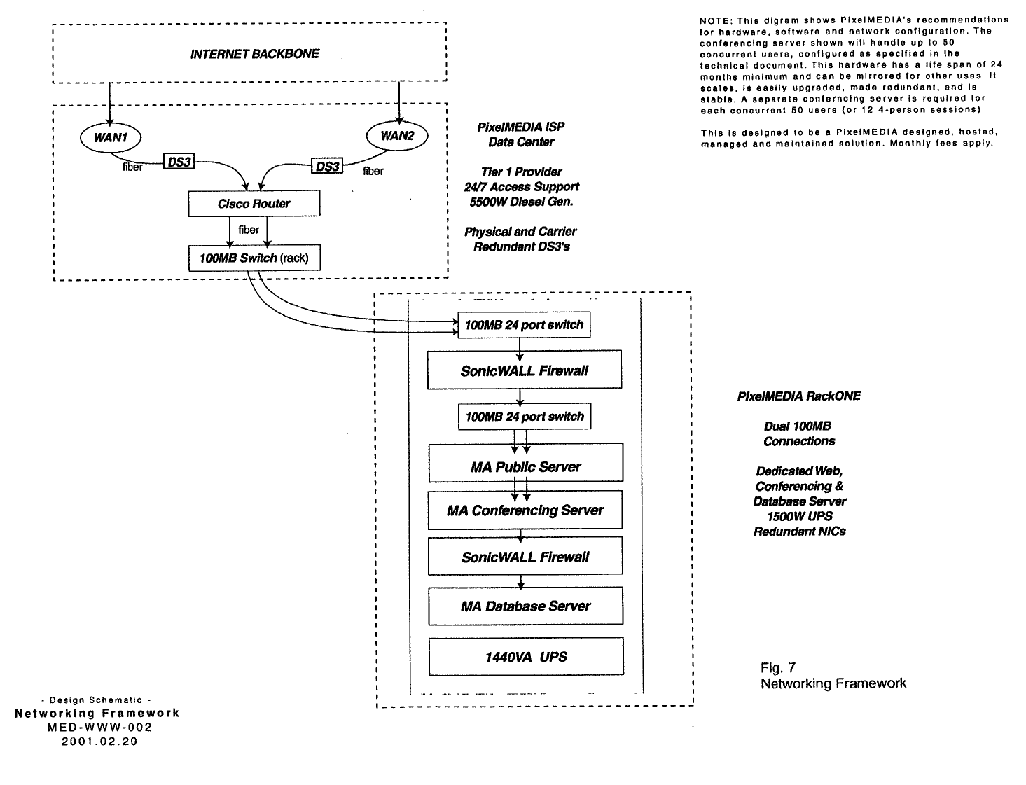

The functionality of the web site is enabled by relationships and interaction among the following five layers (tiers): the client layer (enduser's environment), the presentation layer (page look/feel and services), the business logic layer (rules governing subjects and objects), the resource layer (how data is stored), the hardware & application framework layer (what it runs on). Reference FIGS. 6 and 7.

Overview of Web Client and Server Interaction

Web clients make requests from web servers, which (a) interpret those requests, (b) perform one or more actions (database queries, for example), and (c) return dynamically-generated pages, or pages whose content is customized based on the results of those actions.

Client Layer

The client layer is the collection of various hardware and software components in an end-user's environment that allows that user to interact with an application—the computer internals (processor, memory, hard drive), the operating system and web browser, network connection, peripheral equipment (such as video cameras, speakers, and microphones).

As the most demanding of all web applications, videoconferencing and document sharing imposes significant restrictions on the client environment. To attain a successful quality session with the system, a dedicated T1 for each concurrent four-person session is preferred for inbound and out-bound traffic.

Hardware/Software Requirements—To ensure acceptable levels of audio/video quality during videoconferencing, the preferred embodiment of the computer comprises:

450 mHz to 700 mHz Pentium processor

256 MB RAM

32 MB PCI or AGP Video Card

32bit Sound Blaster or Turtle Beach Sound Card

20 G Hard drive

22″ Monitor running at 1024x768

Intel 100 MB NIC Card

Microsoft Windows 2000 Professional (recommended)

Or Microsoft Windows 98SE, Windows ME

Microsoft DirectX 8

Microsoft Office Professional

Logitech QuickCam Web (USB)

A headset or microphone and speakers

Keyboard and mouse

Presentation Layer

The presentation layer comprises the technologies responsible for interactions between user and web page, most notably the web server and scripting environment. All interaction between users and the system takes place through standard web pages with scripting extensions known as Active Server Pages. These pages are served by a Microsoft Internet Information Server (version 5.0), and may reach users over any type of Internet connection—although, as mentioned previously, participating in videoconferencing-based mediations requires an Internet connection capable of sustaining at least 128 K/s data transfer rates.

Implementation Requirements—Because the web pages preferably utilize Microsoft's Active Server Pages technology, they must reside on a computer running Microsoft's Internet Information Server, version 4.0 or 5.0. To interface properly with the resource layers underneath, the web server must run a current version of the ActiveX Data Objects (ADO) library, which is available through the Microsoft Data Access Components collection. To allow users to upload files over their Internet connection, the server must also have an upload program, such as the Software Artisans SA-FileUp, installed.

Interface with Client Layer—Once all client requirements have been met, the interface between the presentation and client layers is seamless—the web server returns a stream of HTML to the client for display.

Business Logic Layer

The business logic layer defines most of the rules that govern relationships between subjects and objects—answering questions like “can User X perform Action Y on Object Z,” or “does User X's membership in Group Y automatically make him/her a member of Group Z?” Most of the business logic is preferably contained within ASP pages, database stored procedures, and in the CUSeeMe Conferencing Server software. These rules enable (and oversee the operation of): generation of user and session access codes, maintaining types of users and transitions between the user states, sending invitation, confirmation, and rejection e-mails, security enforcement (blocking non-participants from private mediations, for example).

The CUSeeMe Admission Center and CUSeeMe Conferencing Server are the preferred software. The Admission Center validates mediation participants with a seven-part ticket verification process to ensure that only registered users are capable of sending and receiving mediation data. A more complete description of the CUseeMe software is found in the books entitled Meeting Point Conference Server, Version 4.0.5 User Guide, Meeting Point Conference Server, Version 4.0.5 Telnet Interface Guide and CUseeME Web SDK, Version 2.0 User Guide, all published by CUseeMe Networks, Inc. of 542 Amherst Street, Nashua, N.H., the disclosures of which are hereby incorporated by reference herein.

Mediator Controls—While the CUSeeMe software makes it possible to turn video on and off remotely, it does not allow for a sole controller. As noted above, the system of the invention allows controlled “break-away sessions” or caucuses where a sole controller (the mediator) may control the audio and video transmissions of individual participants. The use of DirectX 8.0a drivers enhances this capability. This is client side functionality file within the session directory of the mediation architecture. This customization in accordance with the invention is fully described in the file “mediation.js”, attached hereto as Appendix A, the disclosure of which is hereby incorporated by reference herein.

Performance Tuning—Research and development has yielded enhanced video/audio synchronization with H.263 “dirty rectangles” technology and ideal audio and video system settings to take better advantage of CUSeeMe software capabilities. The preferred configuration file “mpcs.cfg” that has achieved such optimal performance tuning is attached hereto as Appendix B, the disclosure of which is hereby incorporated by reference herein.

Interface with Presentation Layer—The presentation layer connects to the business logic services through Active Server Pages code and the CuWeb ActiveX control (which provides the lower-level videoconferencing services within the web browser interface).

Resource Layer

The Resource Layer Comprises Raw Data—In databases, messaging systems, files, etc., two different types of data stores are employed: some information about mediations is stored within the CUSeeMe Conferencing Server, however, most of it is stored in Microsoft's enterprise-level database—SQL Server 7.0. In addition, the SQL Server database contains all user-related data, and site application metadata (data about the application itself, rather than the components of the application). See Hardware and Application Framework details below.

Microsoft SQL Server 7.0 requires a Windows NT/2000 Server. The CUSeeMe Conferencing Server also requires a Windows NT/2000 Server. For both, the Hardware and Application Framework details discussed below are preferred.

Design Decisions

The data model was built to address the specific application needs, and consists of the database tables shown in FIG. 5 as follows:

users

mediators

mediator_availabilities

mediator specialties

mediator_mediator_specialty_map

mediator_locations

mediator_mediator_location_map

mediation_files The users table is the primary table for user records; there is one entry per system user, no matter what type of user (mediator, end-user, administrator). The mediators table extends the users table, and holds any information, which these users have by virtue of their status as mediators. (All mediators are users, but not all users are mediators.) Currently, this is only biographical information—additional details such as the mediator's location and specialty are stored in separate tables, since there is a one-tomany relationship between each mediator and these items.

The mediator_availabilities table contains time slots for which a particular mediator has confirmed an availability.

The mediator_specialties table contains one entry per specialty e.g. bad faith, medical and legal malpractice, personal injury.

The mediator_locations table contains one entry per location for which a mediator may be authorized to mediate.

The mediator_mediator_specialty_map and mediator_mediator_location_map tables contain one entry per combination of mediator/specialty or mediator/location.

The mediation_files table holds information about each file uploaded by a mediation participant (e.g., file name, user-given name, size, location).

Interface with Business Logic Layer—The business logic layer talks with the resource layer through the ADO Command object (which allows stored procedure execution within the database). Additionally, the business logic residing in ASP code communicates with the resource layer through the ADO Connection and Recordset objects. All logic is applied directly into the pages themselves through a set of includes and are in numerous pages throughout the site requiring user access validation throughout the site.

Hardware and Application Framework Layer

The hardware and application framework layer comprises the physical equipment and software to run the service—including the servers, databases, conferencing and operational applications, operating systems, networking and security infrastructure.

The Hardware and Application Framework Layer—There are four major components to the hardware and application framework layer, in addition so several sub-components, which in essence are supporting components. The major components comprise the following:

The Servers—Web, Conferencing and Database

The Applications—Web, Conferencing, Database and Email

The Operating Systems

Networking—Switches, FireWALLS, Encryption

Hardware Implementation Requirements—The following implementation requirements are based on a fully developed and functional product using a set of servers that are distributed amongst the three major services required to produce a successful session. This allows us to achieve maximize performance within each of the areas; public site, conferencing server(s) and the database server.

System 1—Public Web Server

The public server contains general access pages (home, company, contact info, etc.) and member/participant access points for account and session management and access to mediation tools.

The following specifications are preferred to run a single instance of this service:

Hardware

Dell PowerEdge 2450 (dual power supplies)

Single processor 833 mHz Pentium III

512 MB RAM

PERC single channel 64 MB RAID card

RAID 5 running over 4-9 G 10,000 RPM drives+spare (5 drives total)

20/40 G Internal DAT

Dual Intel 100 MB NIC Cards with load balancing

System 2—Conferencing Server

The conferencing server is designated as a dedicated system tuned and assembled to handle all mediation, training, and in the future conferencing functions, specifically audio/video streaming and session management. Each conferencing server is capable of handling up to 12 concurrent four person sessions. A new instance of this server will be required for every 12 concurrent four person session. A load balancing device and additional application development will also be required in order to distribute requests to the conferencing server throughout two or more instances.

The following specifications are preferred to run a single instance of this service:

Dell PowerEdge 2450

Dual processor 833 mHz Pentium III

1024 MB RAM,

PERC single channel 64 MB RAID card

RAID 5 running over 3-9 G 10,000 RPM drives+spare (4 drives total)

12/24 G DAT

Dual Intel 100 MB NIC Cards bound to a single IP

System 3—Database Server

The database server is designated as a dedicated system tuned and assembled to handle all data storage, session and scheduling requirements.

The following specifications are preferred to run a single instance of this service:

Dell PowerEdge 2450

Single processor 900mHz Pentium 4

512MB RAM,

PERC single channel 64MB RAID card

RAID 5 running over 4—9G 10,000 RPM drives +spare (5 drives total)

12/24G DAT

Dual Intel 100MB NIC Cards with load balancing

Application Requirements—the following application preferences are the basis for most of the core functions of the site. These applications are used in two areas: the back-end web, conferencing and database server and an end-users conferencing station.

Server Applications

Database—Microsoft SQL Server 7

Web Server—Microsoft Internet Information Server 5.0

Videoconferencing—CUSeeMe Conference Server 5.0

Software Artisans SA-FileUp

Email System—IIS Mail Relay

End-user Applications

CUSeeMe Pro 4.0 for Windows (end-user software)

Microsoft Office 2000 Professional

Internet Explorer 5.5 (for Mediation tool)

Netscape 4.0+or Internet Explorer 4.0+(for public site use)

Operating System Requirements—the following operating system requirements were chosen to be the basis for the servers and the end-user conferencing stations. These operating systems are used in two areas; the back-end web, conferencing and database server and an end-users conferencing station.

For the Servers

Windows 2000 Server

For End-user

Windows 2000 Professional

Windows 98SE

Windows ME

Networking Requirements—Firewalls are designed to keep out unwanted hackers and traffic that may not be designed to travel into and across your network or hardware for its intended use. They are also used to secure and verify all traffic coming into the site and the servers contained within it. Two separate firewalls are preferred: Firewall 1 for public site and conference server protection and Firewall 2 for securing access between the public server, the conference server and the database, essentially allowing no unauthorized access except from trusted machines to the database system.

### Security/Privacy

The content of the actual mediations is extremely sensitive and highly confidential. The ADR system and method of the invention enforces strict access control and data security policies.

Mediation Tool Privacy

Audio and video streams are maintained private by:

requiring session-level access codes (one code per session), and user-level access codes (one code per user),

enforcing a 7-part ticket security protocol in the CUSeeMe Conferencing Server and Admission Center settings, and

encrypting the video, audio, and control data streams to prevent lower-level network attacks (e.g., packet sniffing)

Both session-level and user-level access codes are 168-bit (21-byte) unique identifiers, and most codes must be valid for a user to send/receive conference data. Additionally, the data streams that carry the encoded control, audio, and video signals are encrypted (with a proprietary encryption scheme) to prevent interception or tampering. The audio and video signal encryption is handled by the CUSeeMe Conferencing Server and Admissions Center.

User Data Privacy—The privacy of the user data (stored in the databases) is enforced by a standard username/password access control scheme, which requires that users enter valid credentials before gaining access to their account information. All public traffic through the site will not be secured and will be accessible from anywhere in the world and anyone with a compatible web browser. This will allow new users and potential clients to easily view and schedule their initial session through the site prior to becoming a defined member or subscriber/subscriberagent.

Member and Subscriber/Subscriber-agent Privacy—With regard to member privacy, each member's profile is visible to only that member or subscriber administrator and the contents of a mediation (the videoconferencing part) similarly restricted to that mediation's participants. Securing member profile information is assured by storing the information in a database, and forcing them to log in with a username/password combination before gaining access to it. Further, the entire video session may be secured over a PGP-encrypted Virtual Private Network (VPN), or with the Secure Sockets Layer (SSL) protocol.

Payment Processing—All payment processing (and account management) (e.g. credit card billing) may be conducted over an SSL-encrypted connection utilizing an approved clearinghouse for all purchase verification and transaction processing. While credit card information is currently collected at the time that a mediation is scheduled, to make sure that this sensitive information stays private, this information may be sent over an SSL (Secure Sockets Layer) encrypted connection. In the current embodiment of the invention, a valid credit card string (21-digits for VISA) is preferred over the actual card number.

### Application User Scenarios (Use Cases)

For purposes of illustration, the functionality of the web site may be better understood by reference to the various web pages of FIG. 1 and the following use cases that step through the application as an end-user, one step at a time, and describe the interactions with the system.

Scheduling and Billing

Before a session may be joined, it must be scheduled. Any user (even an unregistered site visitor) may schedule a session. There are 4 steps involved in scheduling a session, starting with, for example, choosing a date and time, and ending with a collection of the billing data and the generation of a set of email invites to potential participants.

User/Participant

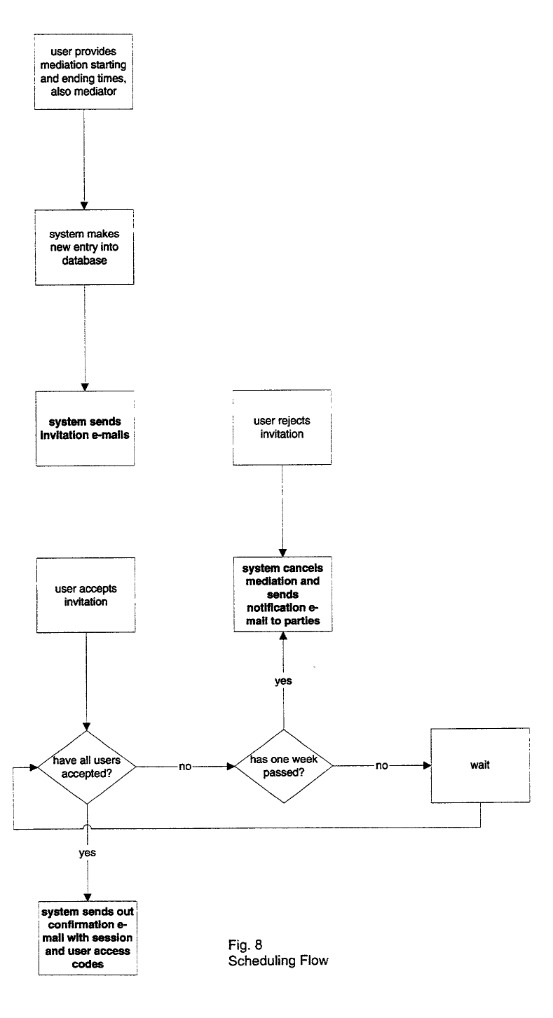

With reference to FIG. 8, users may schedule mediations/training/conferences by: (a) starting and ending times for the particular type of session and (b) a specific mediator/trainer/conference host. The site allows the user to select these items in either order, and these are referred to within the site architecture as schedule-by-time and schedule-by-mediator. These scheduling functions also apply to non-mediation conferencing and training. Additionally, because the list of mediators is long, and because considerations about a mediator's location and specialty affect the suitability of that mediator for a particular user's needs, the site allows users to search for mediators by location and specialty. These options are available on the schedule-by-mediator pages.

When a specific mediator and time have been chosen, the user must enter payment information to continue. Credit card information and bank account information may be provided for credit charging and funds transfer.

Once this information has been validated, the user may invite up to two additional participants (the other parties to the mediation).

At this point, e-mail messages are generated and sent to (a) the user who scheduled the mediation, (b) the other parties to the mediation, and (c) the selected mediator.

All of these messages include information about the selected time and mediator, links to approve or deny participation, and the credentials necessary to log into the mediation (at the scheduled date/time). These credentials consist of a session identifier (for the particular mediation), and a user identifier (which distinguishes each user in the mediation).

In addition, the e-mail message sent to the scheduling user contains confirmation of the billing details, but this information is not sent to the other users.

If the invited participants are already registered users of the site, they need only click on the appropriate approve/deny link and enter their username and password to confirm/reject participation in the mediation. Otherwise, they will need to enter (a) their primary e-mail address, and (b) first and last names, at which point they will become registered users of the site.

If all parties have accepted the invitation, an additional confirmation e-mail will be sent out to the mediating parties (scheduling user plus invitees) and the mediator. The confirmation e-mail will contain session and user identifiers.

Mediator

The mediator or trainer does not participate in the scheduling process—he/she does not receive an initial invitation, nor does he/she receive rejection notices.

The mediator or trainer is only notified if all participants accept their invitations, at which point—like the other participants—they receive user and session access codes. The mediator's or trainer's experience during a session is almost identical to that of the participants with the exception of a set of buttons that allow them to turn on and off video individuals.

Mediators (or the controlling party) enter the mediation just as participants do—using session and user access codes. Their interface is nearly identical, but there is one notable difference between the mediator's or trainer's tool and that of the participants. Since mediators or trainers must be able to meet with each participant privately (hidden from the other participants), the mediator needs to be able to activate and deactivate each participant's ability to send and receive audio/video.

Unlike mediators and trainers, a conference host does initiate the conference process by sending an invitation as described above to participants, who are notified and accept in the same manner described above.

This is accomplished by including, above each participant's video display, a small colored button that toggles that participant's status. A green button indicates that a participant is sending and receiving audio/video; a red button indicates that a participant is currently disabled. (See below for more information on the Mediation tool.)

User/Participant

When a user joins a session (by entering the session access code and clicking “Join”), the system presents the user with a pre-mediation confirmation page with the mediation details -including mediator name, starting and ending times, the names of other participants, and the title and description given to the mediation by its scheduler.

At the bottom of this page, the user is prompted to enter his/her user access code, which is validated by the system.

If the user access code entered is valid, the user is routed to the main page of the mediation tool. (See Mediation section below.)

If the user access code is invalid, the user is routed back to the authentication page with a suitable error message.

Mediation and the Mediation Tool

The Mediation tool is the window that houses the core features required to sustain a scheduled session, including multiple video windows (4 including the mediator), an area to upload Microsoft Office or PDF files for all parties to review (which also allows a participant to delete all files from a designated session), an Instant Messaging and Logout button.

Only the Mediator (or controlling party) sees a set of switches at the top right on each individuals video window for turning their respective streams off and on (currently shown as a green dot).

The Mediation interface and the options within it are shown the mediator web page of FIG. 1. This is the Mediators interface, denoted by a green circle (button) in the top right of the 3 participant windows. All other items in this interface are identical between mediator and participant.

The local user always appears in the top right window—this is where a user of the system would see himself during a scheduled session.

Other elements that are included on this screen include the sessions scheduled date and time, session title and subject, and the name of the Mediator or controlling party.

Site Administration

Most of the site's maintenance is automated (post-mediation directory cleaning, database administration, etc.), but on occasion it may be necessary to intervene (to alter a user's account, perhaps), and this is the role of a special class of users—the site administrators. Authorized users may administer their account information in a self-service area, such as a “My Account” section. Self-service areas allow authorized users to administer and edit their availability, profile information and biographical information as necessary. This will be accomplished by allowing authorized users to login to a secured environment and edit only their records in the appropriate database table. When users submit their changes, their records are then updated.

Due to the nature of the high-security environment, preferably no other administration tools built into the site. All maintenance of account and access information will preferably be manually reviewed and modified by authorized developers.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A web-enabled system for managing dispute resolution among remotely-located parties willing to settle a dispute by participating in a dispute resolution session, the system comprising:
a scheduling module configurable to find one or more mediators in an electronic database based on predefined parameters including parameters indicative of mediator date and time availability;
a storage module configured to store data indicative of a mutually agreed time and date for conducting the dispute resolution session including a respective mediator for conducting the dispute resolution session;
a dispute resolution-conducting module configured to enable respective participants to log into the dispute resolution session, the dispute resolution-conducting module further configured to enable the mediator conducting that dispute resolution session to selectively activate communication devices accessible to each participant to securely transmit audio-visual information over the Internet from one participant to other participants as the dispute resolution session progresses;
a dispute resolution-support module configured to enable transmission of electronic files comprising dispute resolution-supporting material presented by respective participants in the dispute resolution session;
a settlement module configured to generate and transmit respective documents for settling the dispute based on results from the respective dispute resolution session; and
a billing module for tracking usage of the dispute resolution-management system so as to generate billing charges to respective participants.

2. The web-enabled system of claim 1 further comprising a training module configured to provide training to respective participants or students.

3. A web-enabled method for managing dispute resolution among remotely-located parties willing to settle a dispute by participating in a dispute resolution session, the method comprising:
selecting one or more mediators in an electronic database based on pre defined parameters including parameters indicative of mediator date and time availability;
storing data indicative of a mutually agreed time and date for conducting the dispute resolution session including a respective mediator for conducting the dispute resolution session;
enabling respective participants to log into the dispute resolution session;
selectively activating communication devices accessible to each participant to securely transmit audio-visual information over the Internet from one participant to other participants and/or the mediator conducting the dispute resolution session;
transmitting electronic files comprising dispute resolution-supporting material presented by respective participants in the dispute resolution session;
generating respective documents for settling the dispute based on results from the respective dispute resolution session; and
tracking usage of the dispute resolution-management system to generate billing charges to respective participants.

4. The web-enabled method of claim 3 further comprising training respective participants and/or students.

5. A web-enabled portal for managing transactions among remotely-located parties, the system comprising:
a scheduling module configurable to find one or more participants in an electronic database based on predefined parameters including parameters indicative of participant date and time availability;
a storage module configured to store data indicative of a mutually agreed time and date for conducting a session relating to a transaction;
a session-conducting module configured to enable respective participants to log into the session, the session-conducting module further configured to enable a party managing that session to selectively activate communication devices accessible to each participant to securely transmit audio-visual information over the Internet from one participant to other participants as the session progresses;
a transaction-support module configured to enable transmission of electronic files comprising transaction-supporting material presented by respective participants in the session; and
a document-management module configured to generate and transmit respective documents indicative of agreement reached during the session by the participants and further configured to identify items yet to be agreed, if any.

6. The portal of claim 5 wherein a transaction is selected from the group comprising alternative dispute resolution, litigation-related discovery, human resources processes, training, and web video conferencing.

7. A method for conducting on-line mediation, comprising the steps of:
scheduling a mediation with a mediator and a plurality of participants, each having use of a video conferencing web browser that accesses the Internet; and
conducting the mediation via the Internet under the control of the mediator who may conduct private caucuses by selectively deactivating the video conferencing of other participants are not to participate in the private caucus.

8. The method as set forth in claim 7, wherein the step of scheduling the mediation further includes the step of allowing at least one of the participants to find the mediator by name, availability or specialty.

9. The method as set forth in claim 7, wherein the step of scheduling the mediation further includes the step of allowing at least one of the participants view the mediator's calendar to find available dates for conducting the mediation.

10. The method as set forth in claim 7, wherein the step of scheduling the mediation further includes the step of billing for the mediation when the mediation is booked.

11. The method as set forth in claim 7, wherein the step of conducting the mediation further includes the step of allowing the mediation to be reconvened to another date and time.

12. The method as set forth in claim 7, further including the step of allowing the mediator to view a schedule of booked mediations.

13. The method as set forth in claim 7, further including the step of allowing the participants to review their schedule of booked mediations.

14. The method as set forth in claim 7, further including the step of allowing the mediator or the participants to upload a document, file or video for viewing by the others during the mediation.

15. The method as set forth in claim 7, further including the step of allowing the mediator or the participants to send an instant message to one or more of the others during the mediation.

16. The method as set forth in claim 8, wherein the instant message may be sent privately.

17. The method as set forth in claim 7, further including the step of allowing the mediator or the participants to assemble and share settlement, dismissal or release documents during the mediation.

18. The method as set forth in claim 7, further including the step of allowing one or more of the participants to transfer funds to other participants.

19. The method as set forth in claim 7, further including the step of allowing one or more of the participants to transfer funds to a provider of the mediation method in payment for the services of the mediator and the provider.

20. The method as set forth in claim 7, further including the step of providing training to students.

21. A method for conducting on-line conferencing comprising the step of employing a video conferencing server and a plurality of web browsers that are tuned for performance substantially in the configuration reflected in Appendix B.
